(19) United States
(12) Patent Application Publication
(10) Pub. No.: US 2005/0251439 A1
(43) Pub. Date: Nov. 10, 2005

(54) Apparatus and method for assessing progress toward product consumption goals and targeting potential customers

(76) Inventor: George G. Fenich, Metairie, LA (US)

Correspondence Address: Frank C. Eymard;Adams and Reese LLP, 4500 One Shell Square, New Orleans, LA, 70139, US

(21) Appl. No.: 10/839,906

(22) Filed: May 6, 2004

(51) Int. Cl. G06F 17/60

(52) U.S. Cl. 705/10; 705/11

(57) ABSTRACT

An apparatus and method are provided for using a dynamic approach in assessing progress toward product consumption goals and targeting potential customers. The invention uses patterns of how far in advance an order or reservation is a placed, apply those patterns to a future goal, and compare actual performance at a given point in advance of the future goal to the performance estimated by the model to determine whether the business is on track to meet its future goals. The methods can be applied to multiple future consumption goals to determine order-taking requirements as well as to specific market segments. Further, the methods can be used to identify deficiencies in order activity and target customers likely to fill those deficiencies.

### FIELD OF THE INVENTION

The present invention relates to an apparatus and method of assessing progress toward product consumption goals, and more particularly to monitoring progress toward a specific future consumption goal, multiple future consumption goals, as well as targeting potential customers.

### BACKGROUND

Businesses and organizations establish targets or goals for consumption or use of their products and services during future periods. In certain businesses, orders or reservations for a product are made well in advance of use or consumption of the product. Historically, these businesses measured their progress toward achieving or meeting these future goals by comparing orders made or reservations placed at a given point prior to the goal with the ultimate goal.

When most businesses consider the issue of inventory, it is within the context of products or parts that they need on hand and how to store them. Most importantly, since most products are not perishable in the short term, those that are not used in one time frame (e.g. today) can be stored in inventory for use in a future time frame (e.g. tomorrow). Further, products produced in one time frame can be added to those stored in inventory, allowing the business to have even more products to sell or be used.

There are, however, some products that have a very short shelf life and, if not used in time, will either spoil or be lost. This is the case with consumable products such as hotel rooms. For example, if a hotel room is not sold, or used on a given night, it cannot be held in inventory for use at a future date. Thus, it is critical to understand the future demand for these types of consumable products for any given date in order to better match supply.

In most businesses, production, consumption, or sales targets will be set for a future day, month, quarter, year, or even multi-year period. Take for example, the hospitality industry. A city through its sales and marketing arm (e.g. the Convention and Visitors Bureau) will set room night consumption targets for ten or more years in the future. It is not unusual for a city to have commitments from convention groups for use/consumption of a certain number or block of hotel rooms 20 to 30 years in the future.

Businesses use any number of prediction techniques for establishing these future production or consumption targets. One technique is disclosed in U.S. Pat. No. 6,611,726 (the “Crosswhite” patent). Crosswhite discloses a method for determining optimal time series forecasting parameters in an attempt to forecast future demand. Unlike the Crosswhite patent, the present invention does not forecast demand. Rather, it goes beyond Crosswhite by taking estimated demand and ascertaining how many units need to be ordered, or reservations made, in periods leading up to the period(s) of forecasted demand.

Historically, businesses have used a static approach towards monitoring their progress toward these future goals. They consider the ultimate target and then determine how many products have been made, or reservations made, at a date in advance of the date of the future goal. Thus, if the future goal is to have 100 units sold or consumed, the business will ascertain that they have reservations or orders for 50 units at a certain point before the end date, and must obtain another 50 orders or reservations if they are to make their goal.

Current approaches to monitoring progress to a future goal have an inherent weakness or disadvantage. They are relatively static. The comparison is often a simple count: how many units do they want to consume at a future point and how many reservations do they have today.

### SUMMARY OF THE INVENTION

The present invention improves on the static historical approach of monitoring progress toward product consumption goals by introducing a system that uses a dynamic model. One aspect of the present invention uses patterns of how far in advance an order or reservation is placed, applies those patterns to the future goal, and then compares actual performance at a given point in advance of the future goal to the performance estimated by the model to determine whether the business is on track to meet its established future goals.

This method, or model, applies to businesses and organizations that take reservations for the use, or consumption, of their product in advance of use of the product (e.g. hotel rooms) or take orders in advance of delivery of a product (e.g. office buildings). It is extremely helpful for products whose supply is, in the short term, relatively fixed (as in the number of hotel rooms in a hotel or the number of hotel rooms in a city).

The present invention goes beyond the aforementioned static approach of taking reservations or orders in progressing over time toward a goal. Instead, it accounts for the actual pattern of reserving rooms or placing orders by analyzing the pattern of reservation or order activity, ascertaining the consumption goal(s) for future periods, applying the reservation patterns to the future goal in reverse order, determining what number of reservations should have been at any point in advance of the end point/consumption point, comparing the number of reservations that should have been made with those actually made, calculating the difference, reporting the positive or negative variance, and producing a projected goal based on the positive or negative variance.

Utilizing the same principles discussed above, another aspect of this invention can be used to determine the number, or quantity, of orders or reservations needed at a given point to achieve multiple predetermined future goals. As opposed to taking all periods prior to the single period of future consumption into consideration, all periods of future consumption can be back cast to determine a goal for order taking activity in a single period in advance of all those future periods. Thus, looking at a single period in advance of all future consumption periods, takes into account multiple periods of future consumption, ascertains what percentage of the orders are typically placed at that point in advance of all the future consumption periods, and then sums the total for all future periods to determine how many units should be ordered, or reservations made, in that single period.

This aspect of the invention provides a significant analytical tool for setting order taking standards for a sales team or organization. This aspect of the invention can be applied to any period desired, whether it is a day, week, month, business quarter, season, or year. Thus, a hotel might use this invention to direct its sales staff and might, for example, state that the sales team had goals of attracting orders for, or booking: 1,000 room night this January for all years in the future; 1,100 room nights this February for all years in the future; 1,200 room nights this March for all years in the future; through 800 room nights this December for all years in the future.

Utilizing the same principles discussed above, yet another aspect of this invention can be used to analyze the characteristics for sources of business, or market segments, which consume products. This is accomplished by taking into consideration the pattern of how far in advance certain segments of the market place orders, or make reservations, for products whose supply is relatively inelastic in the near future. It also ascertains elements such as market mix by source of business and relative size of each source of business. This process allows a business or organization to better understand its market. It can also be used to target sources of business that will likely make reservations, or place orders, in the time frame needed.

The concept of analyzing market segments, in itself, is not new. Businesses have looked at elements like demographics and psychographics is the past. They have also looked at their sources of business and affixed labels to them, along with the mix of sources of business. What they have not done, and what is done in the present invention, is look at patterns of placing orders or making reservations as applied to, not only the entire market, but to each identifiable segment of the market. In other words, this aspect of the invention takes each sub-set of the market and determines how far in advance of a future consumption date they place orders, and what percentage of the orders, or reservations, are made at each point.

This aspect of the invention allows a company or organization to determine where it is short of meeting its future consumption goals and then narrow down the sources of business that are still likely to make reservations or place orders. Thus, the organization or business can take a narrow, or rifle, approach to finding business rather than a shotgun approach that tries to attract any and all market segments.

Finally, businesses and organizations (especially those in the hospitality business) tend to use very basic, somewhat qualitative approaches to targeting potential customers. Yet another aspect of this invention utilizes the aforementioned principles of assessing progress toward consumption goals and assessing market segments to implement a very sophisticated, empirical approach, to targeting potential customers.

All of the forgoing aspects of the invention can be implemented through a computer-readable medium containing instructions for controlling a data-processing system.

### BRIEF DESCRIPTION OF THE DRAWINGS

FIG. 1 depicts a flow chart of a method of monitoring progress toward a product consumption goal according to the present invention.

FIG. 2 depicts a flow chart of a method of determining order taking activity requirements to achieve multiple future consumption goals according to the present invention.

FIG. 3 depicts a flow chart of a method of analyzing market segments of consumable products according to the present invention.

FIG. 4 depicts a flow chart of a method of targeting potential customers for consumable products according to the present invention.

FIG. 5 depicts an exemplary representation of a computer system utilizing a computer readable medium to perform the methods of the present invention.

FIGS. 6-8 are line charts illustrating patterns of historical order or reservation data, which are used in a detailed example discussed herein.

FIG. 9 is a bar chart illustrating the application of algorithms to the consumption activity in order to ascertain the business mix by month, which is used in a detailed example discussed herein.

FIG. 10 is a table of data illustrating the application of the patterns of FIGS. 6-8 to a future goal, which is used in a detailed example discussed herein.

FIG. 11 is a comparison of actual performance at a given point in advance of a future goal to the performance estimated in order to determine whether the business is on track to meet its established future goal, which is used in a detailed example discussed herein.

FIG. 12 is a table illustrating how the data from previous figures can be used to determine the number, or quantity, of orders or reservations needed at a given point to achieve multiple predetermined future goals, which is used in a detailed example discussed herein.

FIG. 13 is a bar chart showing the monthly flow of peak room nights for an average group, which is used in a detailed example discussed herein.

FIG. 14 is a graphical representation of the patterns of how far in advance groups make tentative reservations, definite reservations, and cancel reservations, which is used in a detailed example discussed herein.

FIGS. 15-26 are tables illustrating the analysis of the business mix, by month, which is used in a detailed example discussed herein.

FIGS. 27-37 are tables illustrating the analysis of the business mix by year for a ten-year period, which is used in a detailed example discussed herein.

FIGS. 38-40 are bar charts illustrating reservation or order taking patterns broken out by source of business or market segment, which is used in a detailed example discussed herein.

FIGS. 41-50 are line charts illustrating the pattern of making tentative reservations or orders, which is used in a detailed example discussed herein.

FIGS. 51-60 are line charts illustrating the pattern of making definite reservations/orders, which is used in a detailed example discussed herein.

FIGS. 61-63 are bar charts illustrating the number of room nights consumed by each market segment, which is used in a detailed example discussed herein.

FIG. 64 is a table of labels for each of the numeric market segments, which is used in a detailed example discussed herein.

FIG. 65 is a chart summarizing the analysis and data from the previous figures.

### PREFERRED EMBODIMENTS OF THE INVENTION

In the following detailed description of the preferred embodiments, reference is made to the accompanying drawings, which form a part hereof, and in which are shown by way of illustration specific embodiments in which the invention may be practiced. It is to be understood that other embodiments may be utilized and structural changes may be made without departing from the scope of the present invention.

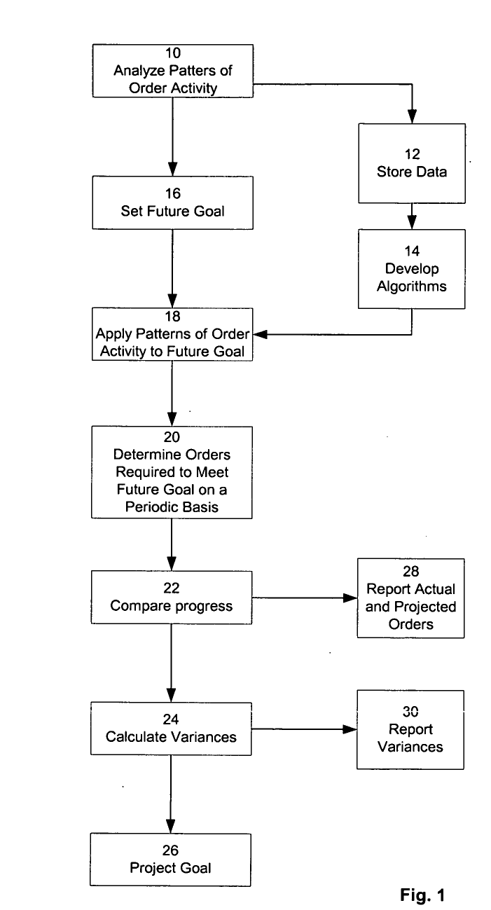

FIG. 1 shows the overall steps of a method of monitoring progress toward a product consumption goal that generally includes: analyzing patterns of order activity (10), storing data in a database (12), developing algorithms simulating patterns of order activity (14), ascertaining a product consumption goal for a point in the future (16), applying the patterns of order activity to the consumption goal (18), determining the number of orders required at any period in advance of the consumption point to meet the consumption goal (20), comparing the number of orders required to meet the consumption goal with the orders actually made in any period in advance of the consumption point (22), calculating variances between the number of orders required to meet the consumption goal and the orders actually made in any period in advance of the consumption point (24), producing a projected goal based on the negative or positive variances (26), reporting the number of orders required to meet the consumption goal and the orders actually made in any period in advance of the consumption point (28), and reporting positive and negative variances (30).

A database is necessary to perform steps (10) through (30). The database typically contains data fields with the following information: identification of the entity making the reservation or order (and committing to consumption of the product), date of consumption of the product (future date), quantity of consumption (i.e. rooms reserved), date reservation was made, date inquiry about the availability of product and intent to reserve was made. The database includes a line or row for each customer, or potential customer, and each row contains the information noted above. In addition to gathering and having access to said data, the database allows for checking the accuracy of the data and making corrections to said data as necessary.

Analyzing patterns of order activity (10) involves calculating how far in advance of the consumption point (end point or order delivery point) a reservation (order) was made. The calculation is “B−A=F” where B is the consumption point, A is the point where the reservation was made and F is the difference between the two or how far in advance the reservation was made. The ‘points’ of reservation (order) can be days, week, months, or years. For example, a reservation made on Jul. 1, 2003 for consumption (delivery, use) on Jul. 1, 2004 was made (a) one-year in advance, (b) 12 months in advance, (c) 52 weeks in advance or (d) 365 days in advance. This becomes the basis for the pattern. It is beneficial to have a large enough number of data points to allow for analysis that is statistically significant at the 0.01 confidence level. The information obtained in analyzing patterns of order activity (10) is then stored in the database shown in step (12).

The next step in this method involves developing algorithms simulating patterns of order activity (14). In this step, algorithms are determined from the historical data that simulate the patterns of order activity. The algorithms include multiple iterations of the formula “B−A=F.” The calculation for how far in advance of the consumption date an order/reservation was placed is done for each date/period that precedes the consumption date (can be days, weeks, months, quarters, seasons, years, etc.). So if the method was applied for months leading up to the consumption point, the calculations would ascertain the percentage of total consumption that was ordered/reserved 12 months prior to consumption, then 11 months prior to consumption, then 10 months prior, and so on through one month prior to consumption. The algorithms ascertain the percentage of total consumption ordered/reserved at each of these “points” prior to the end point.

Ascertaining a product consumption goal for a point in the future (16) includes determining the date, in the future, the product is going to be consumed, delivered, or used (this can include a certain day, week, month, business quarter, year, or other ‘points’) and determining the quantity of consumption (i.e. rooms reserved, orders placed) the entity (company, city, etc) plans or budgets to have consumed or sold in the future.

The next step, applying the patterns of order activity to the consumption goal (18), applies the reservation patterns established in steps (10) and (14) to the consumption goals established in (16). The result is a model that shows, for each period in advance of the consumption date, what number of units should have been reserved, in order to achieve the established consumption goal. Thus, the number of orders required at any period in advance of the consumption point to meet the consumption goal is established as set forth in step (20).

The next steps, comparing the number of orders required to meet the consumption goal with the orders actually made in any period in advance of the consumption point (22) and reporting the number of orders required to meet the consumption goal and the orders actually made in any period in advance of the consumption point (28), require determining the actual number of reservations (or orders placed) that had actually been made by a given period in advance of the consumption period and comparing it to the number of orders/reservations that the model/method shows should have been made at a given point in advance of the future consumption period (date). For each period prior to the consumption period, the number of reservations (orders) for units (rooms) that the model shows should have been made may be listed in a report along with the number of reservations (orders) for units (rooms) that have actually been made as indicated in step (28).

The next steps, calculating variances between the number of orders required to meet the consumption goal and the orders actually made in any period in advance of the consumption point (24) and reporting positive and negative variances (30), are accomplished by mathematically comparing what should have been reserved to what has actually transpired. A variance report is then produced for each future period. This variance report shows is what future periods the organization, at a given date prior to the end period (consumption date) has more reservations than the historical model shows it normally would have had and for those periods where it has fewer reservations than it should have. This is accomplished by subtracting the number of units the model shows should have been made from the number of reservations actually made. If the remainder is positive, there is a positive variance and the organization is ahead of pace for achieving its consumption goal. If the remainder is negative, the organization is not on pace to achieve its consumption goal. The calculated variances can be stored for future reference. The variances can also be converted from a positive or negative number to a percentage of what the model/method shows as the goal.

The next step, producing a projected goal based on the negative or positive variances (26), takes the percentage variance and applies it to the end period consumption goal. That goal is adjusted either, up by the positive percentage variance, or down by the negative percentage variance. This new goal may be labeled ‘projected goal’ or ‘projection’ and reported in a graph or other report.

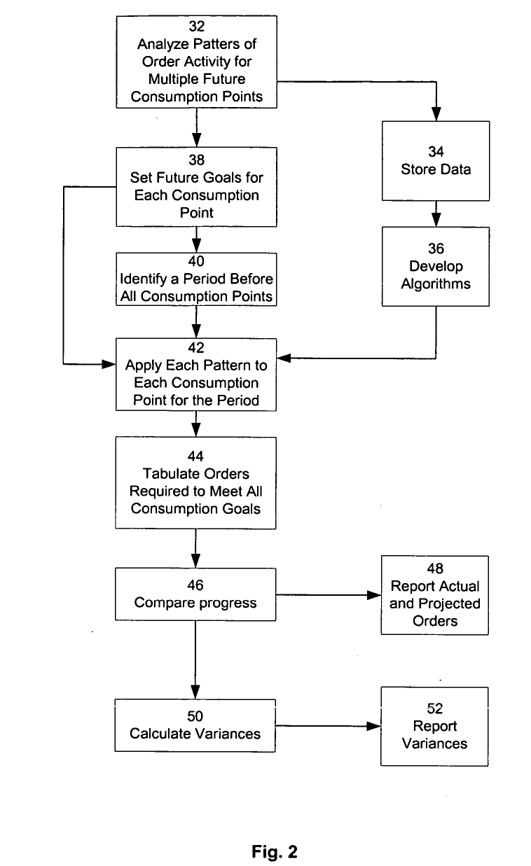

FIG. 2 shows the overall steps of a method of determining ordering activity requirements to achieve multiple future consumption goals that generally includes: analyzing patterns of order activity for multiple future consumption points (32), storing data in a database (34), developing algorithms simulating patterns of order activity (36), ascertaining product consumption goals for the future consumption points (38), identifying a period occurring before any of the future consumption points (40), applying the patterns of order activity for each future consumption point to the period consumption goals (44), comparing the total number of orders required to be placed with the orders actually made (46), reporting the total number of orders required to be placed and the orders actually made (48), calculating variances between the total number of orders required and the orders actually made for a period or multiple periods (50), and reporting variances (52).

Steps (32) through (52) require the use of a database. One example is a database that contains the following data field information: identification of the entity making the reservation or order (and committing to consumption of the product), date of consumption of the product (future date), quantity of consumption (i.e. rooms reserved), date reservation was made, date inquiry about the availability of product and intent to reserve was made. The database includes a line (row) for each customer, or potential customer, and each row contains the information noted above. In addition to gathering and having access to said data, the data base allows for checking the accuracy of the data and making corrections to said data as necessary.

Analyzing patterns of order activity for multiple future consumption points (32) is performed in a similar manner to single future consumption point described above. The analysis involves calculating how far in advance of a particular consumption point (end point or order delivery point) a reservation (order) was made. The calculation is “B−A=F” where B is the consumption point, A is the point where the reservation was made and F is the difference between the two or how far in advance the reservation was made. Patterns for all future consumption points must be ascertained. The information obtained in analyzing patterns of order activity for multiple consumption points (32) is then stored in the database in step (34).

As was the case in the description above for a single future consumption point, the next step in the method involves developing algorithms simulating patterns of order activity (36). The algorithms are determined from the historical data that simulate the patterns of order activity. Multiple algorithms are determined for each future consumption point.

Ascertaining product consumption goals for the future consumption points (38) requires determining the dates, in the future, the product is going to be consumed, delivered, or used (this can include a certain day, week, month, business quarter, year, or other ‘points’) and determining the quantity of consumption (i.e. rooms reserved, orders placed) the entity (company, city, etc) plans or budgets to have consumed or sold in the future at each future consumption point.

In the next step, identifying a period occurring before any of the future consumption points (40), a date is arbitrarily chosen for analysis. For example, a hotel might wish to choose the month of July for analysis in terms of how many reservations/orders for all future consumption periods must be made in July if all of those future consumption goals are to be met. Multiple single points can be chosen and the processes in this invention applied many times. For example, a hotel may wish to ascertain how many reservations must be taken in each month of this year (January, February, March . . . December) in order to reach the goals for all future years (months).

The next step, applying the patterns of order activity for each future consumption point to the period (42), is a multiple action step, or is done in a series of iterations. The patterns of order or reservation activity analyzed in step (32) and algorithms developed in step (36) are applied to each of the periods of future consumption in inverse order. Thus, for the period chosen, the pattern that shows the percentage of the total consumption that would have been ordered this far in advance of the first future date of consumption is applied to the consumption goal for that future period. Then, the pattern is applied to the second future date, then to the third etc. The results are then summed to ascertain the total quantity of units that must be ordered, or reserved, in the chosen period if the goals of all future periods are to be met. Thus, the number of orders required, for the period, to meet all the consumption goals is established as set forth in step (44).

For example, if the consumption goals for the next five periods are 1,000 for period A, 1,100 for period B, 1,200 for period C, 1,300 for period D, and 1,400 for period E. And if the model shows the following patterns: 60% book one period in advance of period A; 40% book/reserve two periods in advance of period B, 15% book three periods in advance of period C; 10% book four period in advance of period D; and 1% book five periods in advance of period E. Then the model might show that 1,364 units need to be booked/reserved/ordered in the period chosen in order to meet, or be on track to meet, the targets for those five future periods (Formula: QCD=(period A times 0.6)+(period B times 0.4)+(period C times 0.15)+(period D times 0.10)+(period E times 0.01) where QCD is Quantity on Chosen Date). The result can be shown in a report that includes one or more (multiple) Quantity on Chosen Date(s). For example, a report might show, for each month in a calendar year, how may units need to be ordered, or reserved, for all dates in the future.

The next steps, comparing the number of orders required to meet the consumption goals with the orders actually made (46) and reporting the number of orders required to meet the consumption goals and the orders actually made (48), require determining the actual number of reservations (or orders placed) that had actually been made by the chosen period and comparing it to the number of orders/reservations that the model/method shows should have been. For the period prior to the consumption period, the number of reservations (orders) for units (rooms) that the model shows should have been made may be listed in a report along with the number of reservations (orders) for units (rooms) that have actually been made as indicated in step (48).

The next steps, calculating variances between the total number of orders required and the orders actually made for the period or multiple periods (50) and reporting variances (52), are accomplished by mathematically comparing what should have been reserved to what has actually transpired. A variance report is then produced for the future period or for multiple future periods. This variance report shows in what future period (or for multiple periods) the organization, at a given date prior to the end period (consumption date) has more reservations than the method/model shows it normally would have had and for those periods where it has fewer reservations than it should have. This is accomplished by subtracting the number of units the method/model shows should have been made from the number of reservations actually made. If the remainder is positive, there is a positive variance and the organization is ahead of pace for achieving its consumption goal. If the remainder is negative, the organization is not on pace to achieve its consumption goal. The calculated variances can be stored for future reference. The variances can also be converted from a positive or negative number to a percentage of what the model/method shows as the goal.

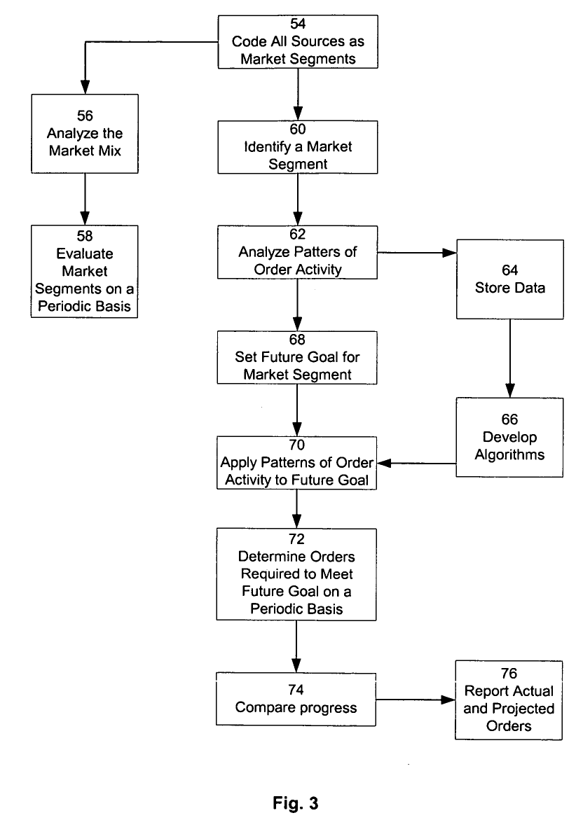

FIG. 3 shows the overall steps of a method of analyzing market segments of consumable products that generally includes: coding all sources of business as market segments (54); analyzing the market mix (56), evaluating market segments on a periodic basis (58), identifying an individual market segment (60), analyzing patterns of order activity for the market segment (62), storing data in a database (64), developing algorithms simulating patterns of order activity (66), ascertaining a product consumption goal for the market segment at a point in the future (68), applying the patterns of order activity to the consumption goal (70), determining the number of orders required at any period in advance of the consumption point to meet the consumption goal (72), comparing the number of orders required to meet the consumption goal with the orders actually made in any period in advance of the consumption point (74), and reporting the number of orders required to meet the consumption goal and the orders actually made in any period in advance of the consumption point (76).

As with Steps (32) through (52), Steps (54) through (76) also require the use of a database. The exemplary database may contain data fields having similar information as those given above; however, additional fields that identify each entry according to some market segment code, or market segment descriptor may also be employed. For example, in the convention business there are market segments, or sources of business identified as Social, Military, Educational, Religious, Fraternal, Corporate, Association, etc. These refer to the ‘one word’ that best describes the type of organization that might be organizing a convention and, thus, reserving rooms. The International Association of Convention and Visitors Bureaus used a pre-determined taxonomy that included 26 different labels for sources of business (Gaels Code). Also, in addition to gathering and having access to said data, the database should allow for checking the accuracy of the data and making corrections to said data as necessary.

Coding all sources of business as market segments (54) involves gathering company data from the database and placing each entry in a particular ‘source of business category’ and labeling it as such.

Analyzing the market mix (56) involves analyzing data to determine the proportion of the total, or aggregate, business each market segment represents. This provides an overview of the relative strength, or importance, of each segment.

Evaluating market segments on a periodic basis (58) involves analyzing the market mix by month, year or any other periodic basis. When analyzing the market mix by month, the mix of business that occurs in each of a series of periods (days, weeks, months, business quarters, years, etc.) is analyzed to determine the mix of sources of business. Thus, in a hotel, it may be found that the majority of room nights were consumed by corporate travelers, the next highest by travelers with associations, third highest by travelers on bus tours, etc. This is done for all periods (days, weeks, months, etc.). The output of this step can be used with the method of monitoring progress toward a product consumption goal as set forth in steps (10) through (30) as shown in FIG. 1. Thus, the organization that finds itself short of where it should be in a given January, can look at the January output from this step to target those sources of businesses, or groups, who usually come to the hotel (consume room nights) in January.

When analyzing market mix by year (not by source code) the output shows the business how its mix is changing over a number of periods, usually years (but it could be days, weeks, months, business quarters, seasons, etc.). In the case of a hotel, this can be used to understand who came years ago relative to who comes now. This information can be used in strategic planning to ascertain effectiveness of marketing efforts targeted toward certain market segments.

Analyzing patterns of order activity for the market segments (62) involves calculating how far in advance of the consumption point (end point or order delivery point) a reservation (order) was made. This is performed similarly to the calculations described in the previous examples. The information obtained in analyzing patterns of order activity (62) is then stored in a database in step (64).

The next step in this method involves developing algorithms simulating patterns of order activity (66). In this step, algorithms are determined from the historical data that simulate the patterns of order activity.

Ascertaining a product consumption goal for the market segments at a point in the future (68) includes determining the date, in the future, the product is going to be consumed, delivered, or used (this can include a certain day, week, month, business quarter, year, or other ‘points’) and determining the quantity of consumption (i.e. rooms reserved, orders placed) the entity (company, city, etc) plans or budgets to have consumed or sold in the future.

The next step, applying the patterns of order activity to the consumption goal (70), applies the reservation patterns established in steps (62) and (66) to the consumption goals established in (68). The result is a model that shows, for each period in advance of the consumption date, what number of units should have been reserved, in order to achieve the established consumption goal. Thus, the number of orders required at any period in advance of the consumption point to meet the consumption goal is established as set forth in step (72).

The next steps, comparing the number of orders required to meet the consumption goal with the orders actually made in any period in advance of the consumption point (74) and reporting the number of orders required to meet the consumption goal and the orders actually made in any period in advance of the consumption point (76), require determining the actual number of reservations (or orders placed) that had actually been made by a given period in advance of the consumption period and comparing it to the number of orders/reservations that the model/method shows should have been made at a given point in advance of the future consumption period (date). For each period prior to the consumption period, the number of reservations (orders) for units (rooms) that the model shows should have been made may be listed in a report along with the number of reservations (orders) for units (rooms) that have actually been made as indicated in step (76).

The output from steps (54) through (76) can be used in conjunction with the output of the method of monitoring progress toward a product consumption goal as set forth in steps (10) through (30) as shown in FIG. 1. When a company or organization sees it is short of where it should be, it can determine how far in advance of the future consumption date they are, and use this information to determine the sources of business who usually place orders on or after this date. Thus, they ran target the most likely candidates for conversion or candidates who are most likely to place the order (make the reservation). This information can be represented in bar charts or line graphs, with the latter showing detail in terms of the percentage of orders placed at every point prior to the date of consumption.

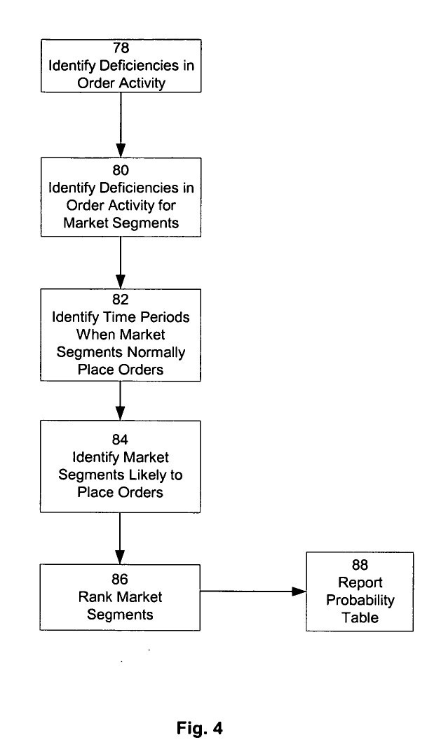

FIG. 4 shows the overall steps of a method of targeting potential customers for consumable products that generally includes: identifying deficiencies in order activity in a period in advance of the consumption goal (78), identifying deficiencies in order activity for individual market segments in a period in advance of the consumption goal (80), identifying time periods when market segments typically place orders (82), identifying market segments likely to place orders (84), ranking deficient market segments based o their patterns of order activity (86), and reporting market segment likely to place orders in a probability table (88).

Identifying deficiencies in order activity in a period in advance of the consumption goal (78) utilizes the output from the steps (10) through (30) to determine, for each future period, where a company or organization is short or behind of where it should be, at a given point in advance of the future consumption date.

Identifying deficiencies in order activity for individual market segments in a period in advance of the consumption goal (80) utilizes the output from steps (54) through (76), as applicable to the business mix by period (day, week, month, business quarter, year), and applies it to the output from step (78). Thus, for each period where there is a negative variance, the present invention ascertains what period that is (say January) and uses the ‘market mix’ output from steps (54) through (76) to ascertain what market segments will typically consume the product in that period. For example, it might be found that in January, the largest piece of the market mix is from the corporate segment, then the social groups segment, then the bus groups segment, etc. In this way, an organization can focus its efforts on the types of buyers who normally consume their product during that time frame.

The next steps, identifying time periods when market segments typically place orders (82), identifying market segments likely to place orders (84) and ranking deficient market segments based on their patterns of order activity (86), evaluate the output from step (80) (who is likely to consume) and then take the output from the market mix analysis (steps (54) through (76) to ascertain how far in advance each of the segments of the market typically place orders or make reservations. This has the effect of further focusing the sales efforts of the organization by ranking the sources of business in terms of how far in advance they place orders. Thus, the organization trying to fill areas lacking in orders or reservations can see that some sources of business would have typically placed their orders already, while others would not, thus making the latter better prospects for conversion to a sale/order.

Reporting market segment likely to place orders in a probability table (88) takes the output from steps (78) through (86) and converts it into a probability table. Thus, it takes the percentages identified in steps (78) through (86) and applies them in sequential order to determine the probability that a source of business who normally consumes the product in a given period along with the probability that it is still within its order placing or booking time window. This shows, for each source of business, which the organization should target and what their probability of conversion to a sale is. The result is a very sophisticated, multi component process that allows a company to, not only target market segments, but know in advance what their probability of success is.

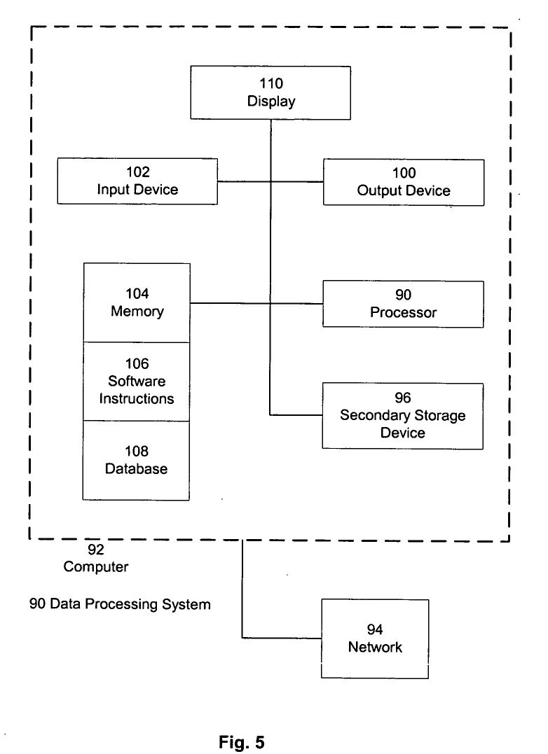

FIG. 5 depicts an exemplary data processing system 90 suitable for practicing methods consistent with the present invention. The data processing system 90 includes computer 92 which may be connected to a network 94. Computer 92 includes a secondary storage device 96, a processor 98, an output device 100, an input device 102, and a memory 104. Memory 104 further includes software instructions 106 and database 108. Software instructions 106 coordinate data processing system 90 in performing the method of monitoring progress toward a product consumption goal as set forth in FIG. 1, steps (10) through (30), the method of determining ordering taking activity requirement to achieve multiple future consumption goals as set forth in FIG. 2, steps (32) through (52), the method of analyzing market segments of consumable products as set forth in FIG. 3, steps (54) through (76), and the method of targeting potential customers for consumable products as set forth in FIG. 4, steps (78) through (88).

Software instructions 106 and input device 102 provide for a user interface that permits input and manipulation of data. Software instructions 106 allow for input, retrieval and manipulation of data in database 108 as required by steps (10) through (88) of the present invention. Software instructions 106 further provide for the display and output of data and reports as set forth in steps (10) through (88) of the present invention.

One skilled in the art will appreciate that data processing system (90) may contain additional or different components. For example, the software instructions 106 may reside on another computer connected to the network 94. Also there may be multiple computers and multiple networks. Further, although aspects of the present invention are described as being stored in memory 104, which including database 108, one skilled in the art will appreciate that these aspects can also be stored on or read from other types of computer-readable media, such as secondary storage devices 96 including hard disks, floppy discs, a CD ROM, or other forms of RAM or ROM.

The following is an example of the application of the apparatus and method. The example focuses on the analysis of hotel room reservations made by various convention groups for a particular city. The data set used to illustrate the example includes over 2,000 observations with fields that include: group name, group identification number, source of business category, month in which the group went tentative, month in which the group went definite (i.e. made a reservation), month the event was held (to be held), number of room nights reserved, number of room nights consumed in total, number of room nights consumed on the busiest day, and actual room night consumption over a five year period.

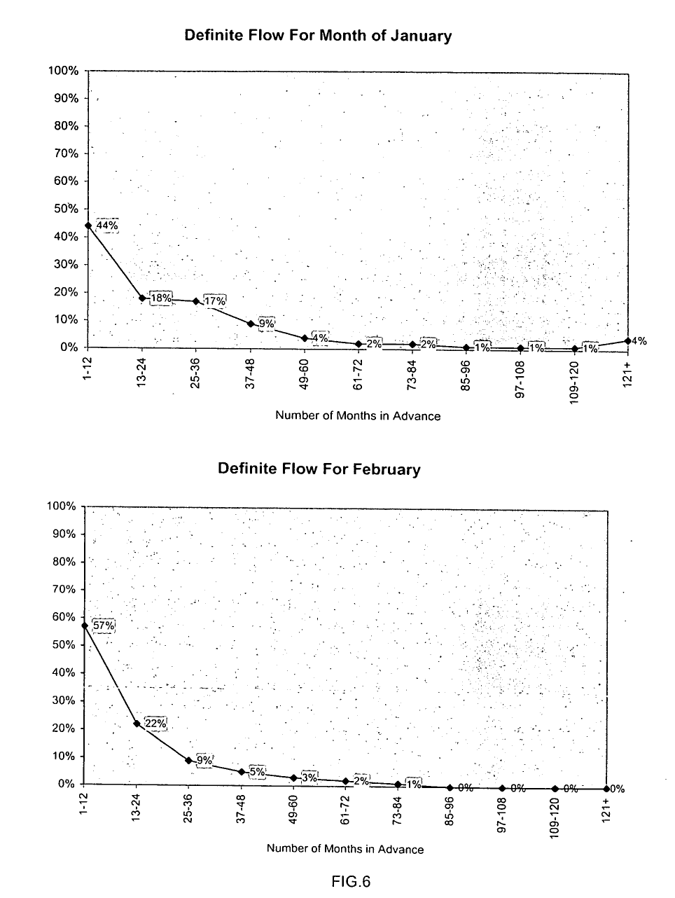

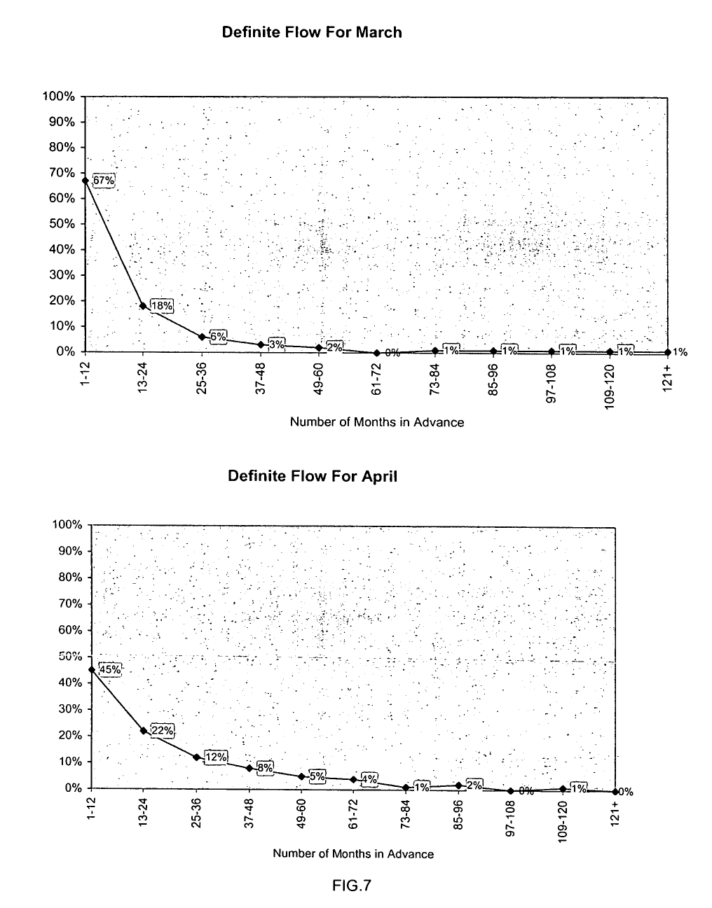

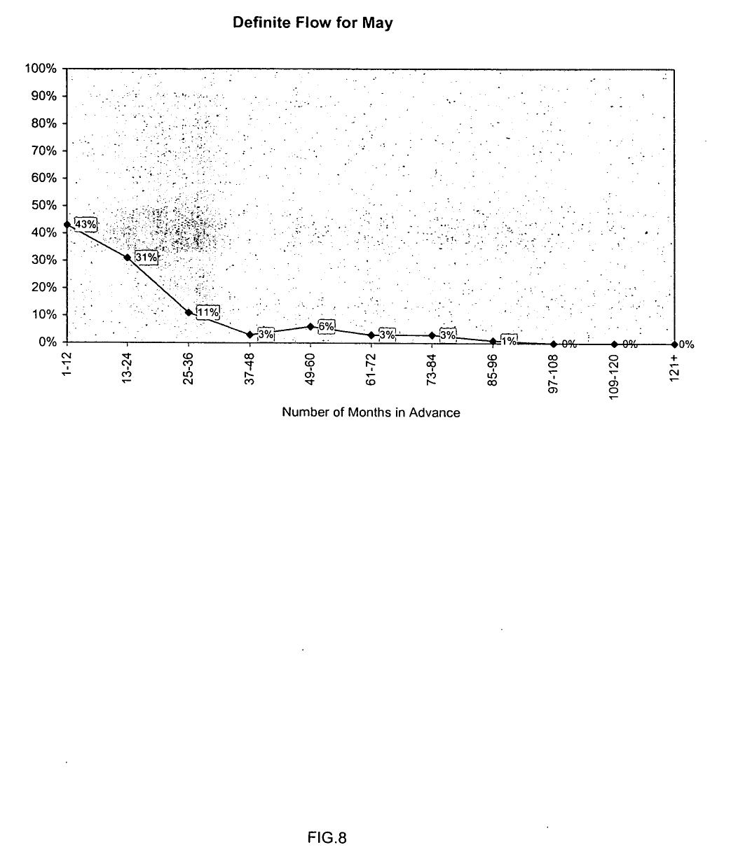

FIGS. 6-8 illustrate how patterns of historical order or reservation data may be used. The figures provide exemplary data for five arbitrary months. As discussed above, algorithms are applied to the months of January through May in the data set. Focusing on the month of January, the results show that 44% of the of the convention groups made their reservation (went definite) between one and twelve months in advance of their event, 18% made their reservation 13 to 24 months in advance, 17% made reservations 25 to 36 months in advance, etc, and 4% of the groups made reservations over 121 months in advance. The graphs presented in the example have the patter grouped into blocks (i.e. 1 to 12 months in advance). It is possible to vary the size of the blocks, for example the patterns may be grouped into blocks of seasons, quarters, months, weeks, days, etc.; however, for ease of illustration, twelve month blocks were arbitrarily selected. While only January through May are depicted in FIGS. 6-8, similar graphs would be generated fro the remaining months of the year.

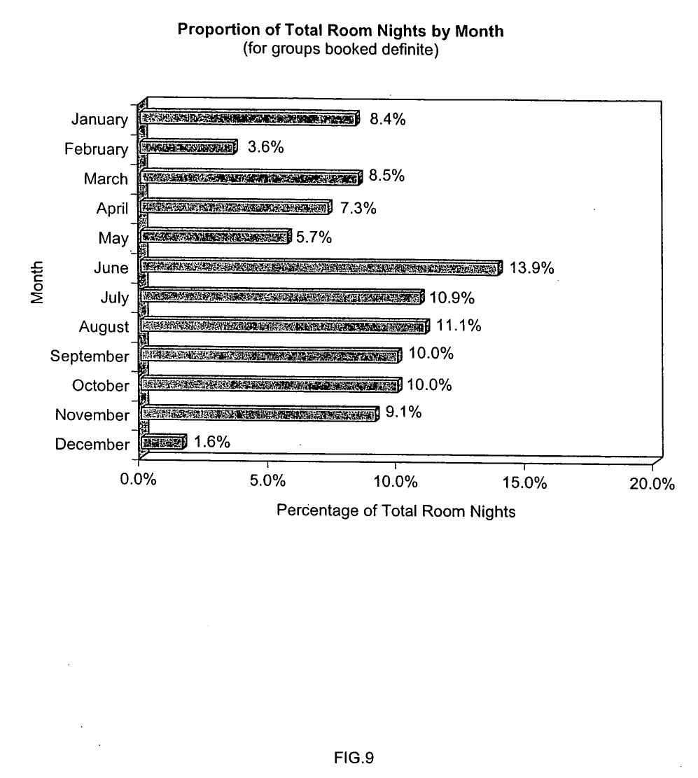

FIG. 9 illustrates the application of the algorithms to the consumption activity to ascertain the business mix by month. This output shows, for this example, that 8.4% of all groups making reservations consumed those products/rooms in the month of January. Further, 3.6% use the rooms in February, 8.5% in March, 7.3% in April, etc.

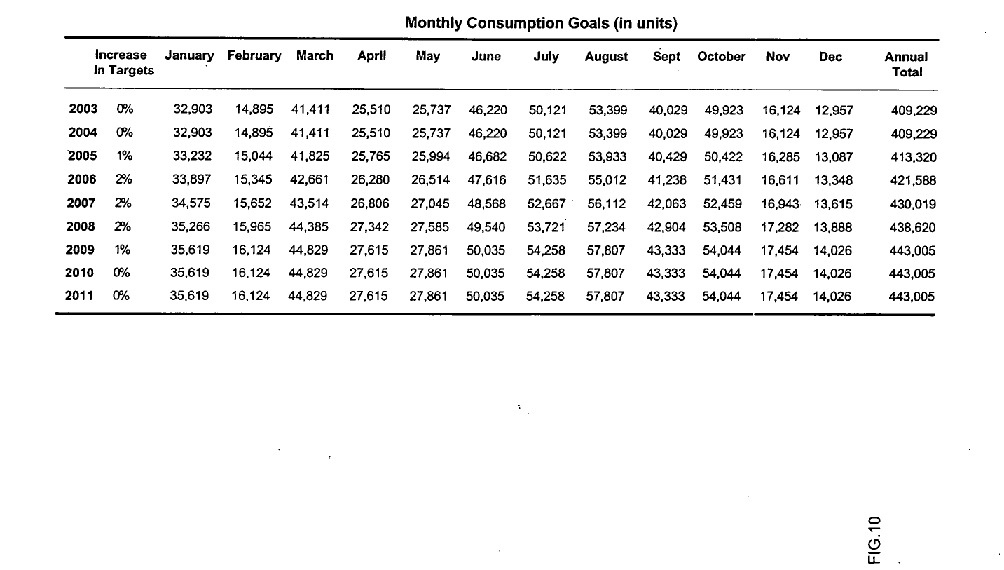

FIG. 10 illustrates the application the patterns to a future goal. The first part of this application is to ascertain the future goal or goals. In the extant example, goals are set for the years 2003 through 2011 as represented in FIG. 10. In this case, the initial goal was set at 409,229 units/hotel rooms. This was done by calculating the actual number of room nights consumed over the previous three years and determining an average/mean. Other methods of establishing goals may be employed.

The next part of this aspect of the application is to determine a growth rate for future goals. In the example, predictions made by Price Waterhouse Coopers in their annual report on the Hotel Industry suggest that demand for hotel rooms will remain flat for the years 2003 and 2004, increase by 1% in 2005, 2% in 2006, 2% in 2007, etc. These percentage increases are applied to the base year goal of 409,229 and ultimately reaches a goal of 43,005 in the year 2011.

In the next part of the application, the output from FIG. 9 is applied along with the data from FIGS. 6-8 to yield future goals by month, which are also illustrated in FIG. 10. Thus, the goal for January of 2003 is 32,903, for February 2003 is 14,895, for March 2003 is 41,441, through December 2011 where the goal is 14,026.

The nest part of the application is to compare actual performance at a given point in advance of the future goal to the performance estimated in order to determine whether the business is on track to meet its established future goal.

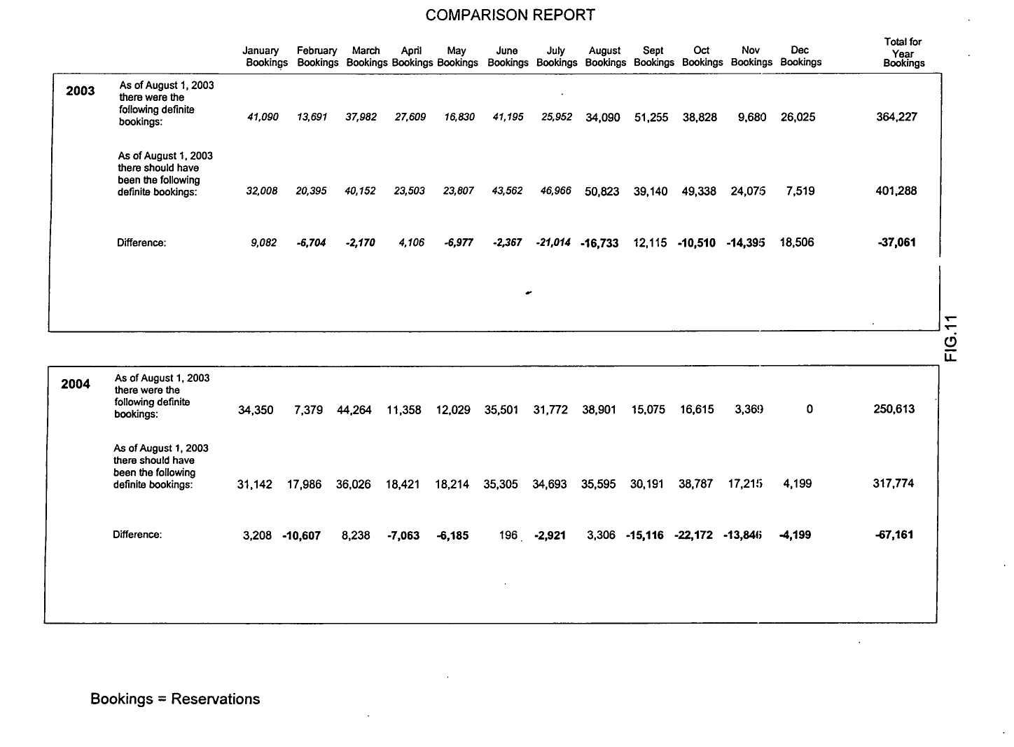

FIG. 11 provides an illustration for the extant example for all months in 2003 and 2004. This could be performed for all months or periods under consideration (i.e. following the current example out through the year 2011). In this aspect of the invention, the output of the model algorithms as applied to the consumption goals are listed on line two as “there should have been the following bookings” as of, in this example, Aug. 1, 2003. The first line is an analysis of the reservations actually made (orders placed) and the quantity (number of rooms) for each month and the total for the year. Then, the difference is calculated and reported on line three. So, as can be seen in FIG. 11, there were 41,090 rooms reserved for January of 2003, the model shows that 32,008 should have been reserved as of August (or 5 months prior to ultimate consumption in January) and this organization was 9,082 room nights ahead of their dynamic pace for January. In February, there were 13,691 definite room nights reserved, the model showed that 20,395 should have been reserved that far in advance of February and that the organization was 6,704 room nights short of where it should have been as of August 1. For the year, there were 364,227 room nights reserved, the model shows there should have been 401,288. Thus they are short 37,061 for the year. While all the months in 2003 and 2004 are provided in this example, the analysis could be performed for as many years or months in the future as supported by the data.

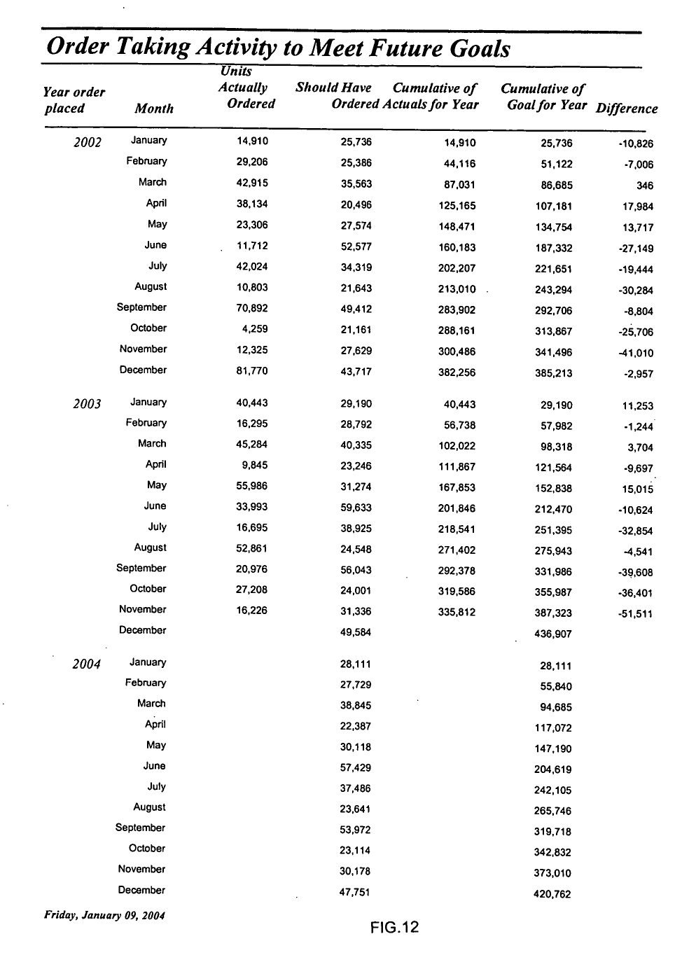

FIG. 12 illustrates how the data provided by the invention can be used to determine the number, or quantity, of orders or reservations needed at a given point to achieve multiple predetermined future goals. FIG. 12 shows the operationalization of this aspect of the invention. (Note: a different data set was used for this example than the previous examples). The algorithms and processes of the invention were applied to goals for all future months, or the inverse of the previous applications. The application was run on Jan. 9, 2004 and applied to the previous years (2002, 2003) to show what transpired and then to the year 2004 to provide the predictive aspect of the invention. The first column indicates the year, the second column shows each month. The third column shows what orders had actually been placed for the aggregate of all future months while the fourth column shows what the model algorithms indicate should have been ordered for each month. Columns five and six put forth a running total for each year while the last column shows the difference, or positive versus negative variance. Since no orders had been placed for any months in 2004, columns three and five are blank and will be filled in as each of those months occurs. One particular strength of this dynamic and predictive aspect of the invention is that this output provides the organization/company with an order taking/reservation target for the future that can guide their sales efforts.

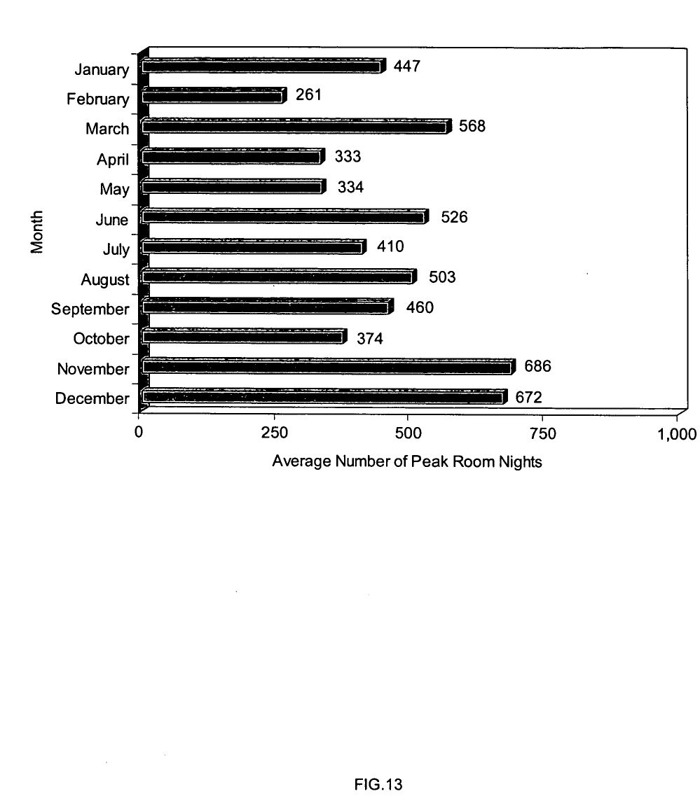

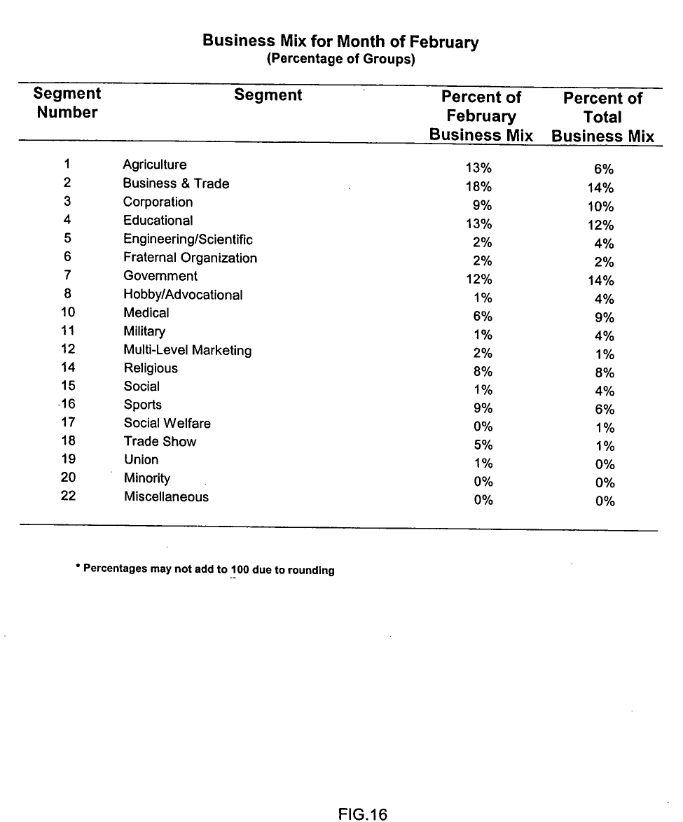

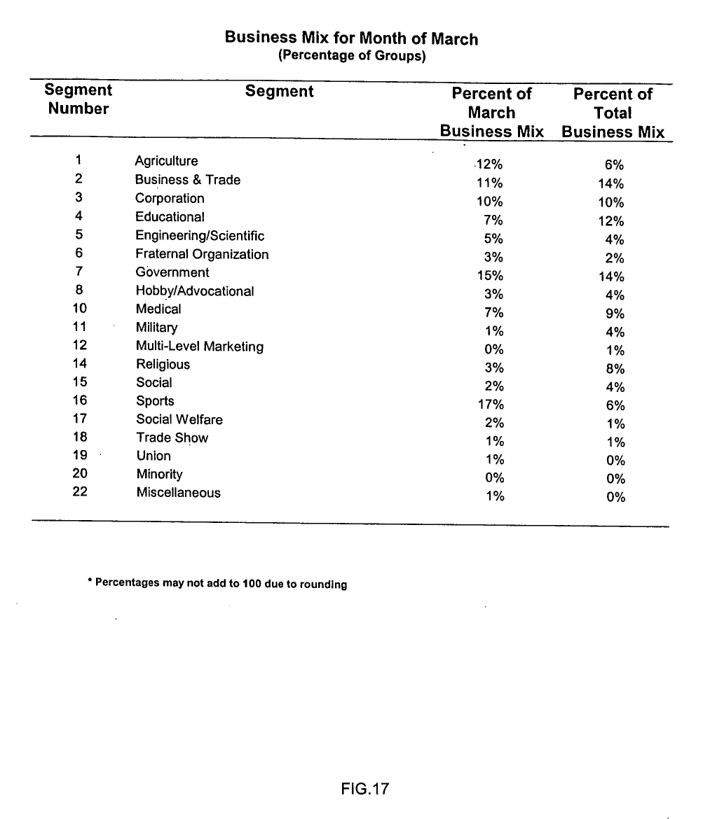

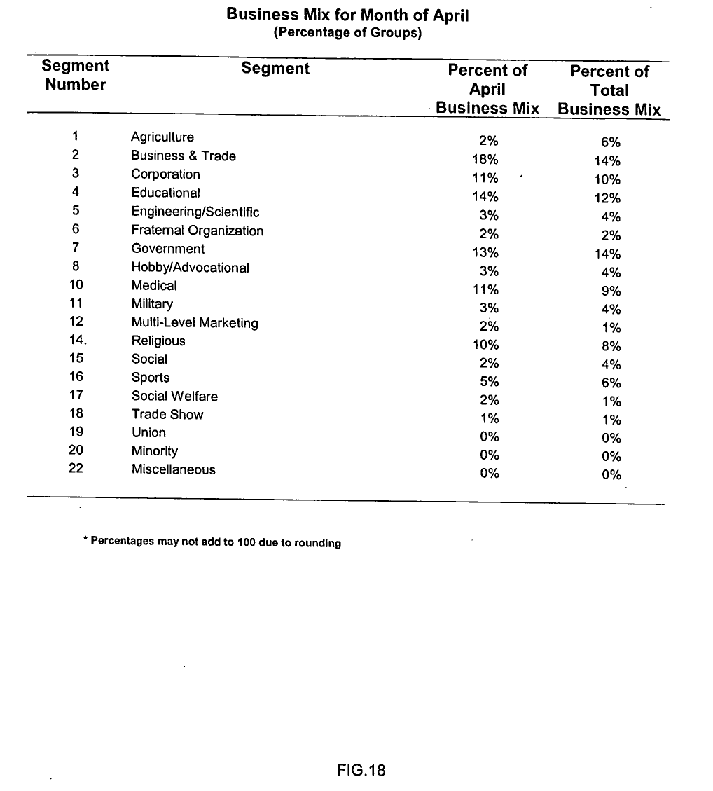

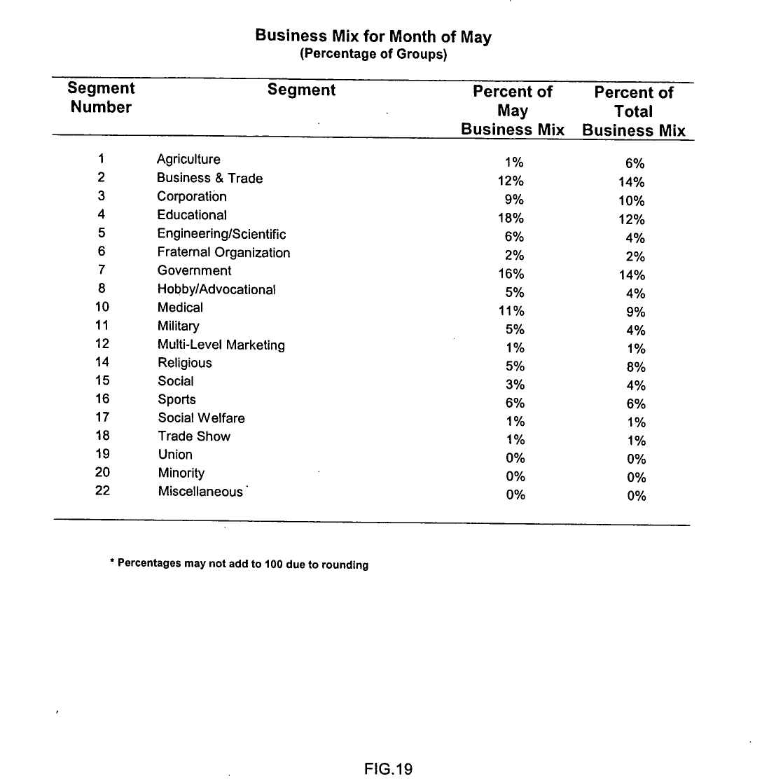

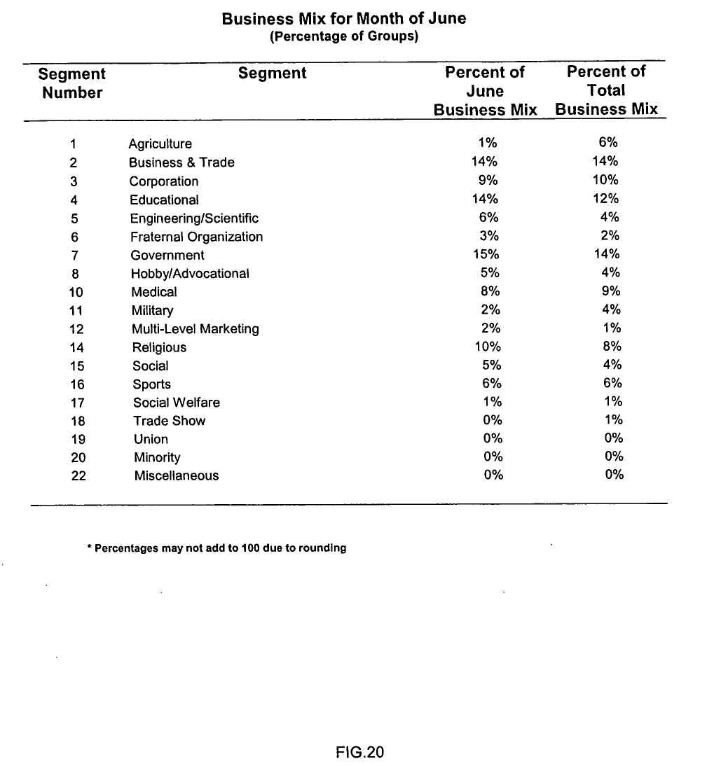

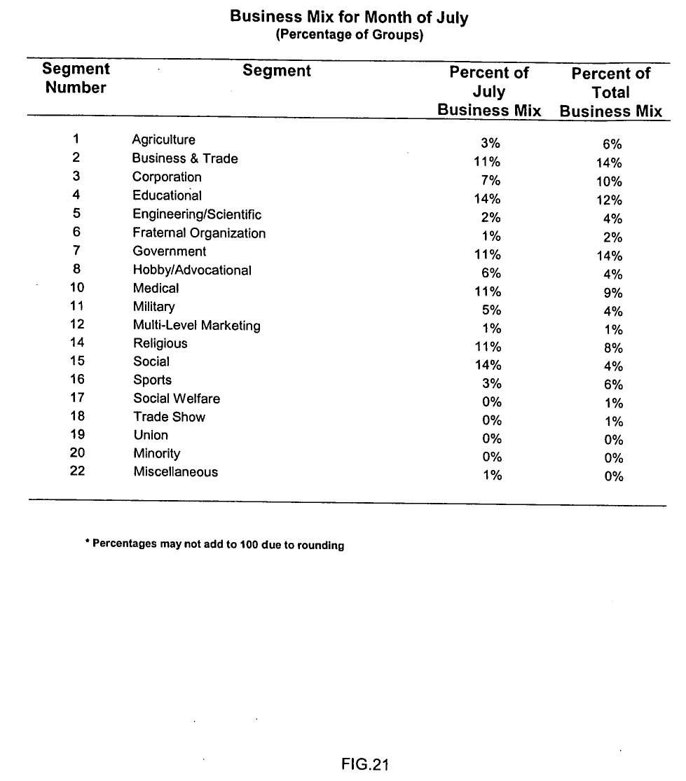

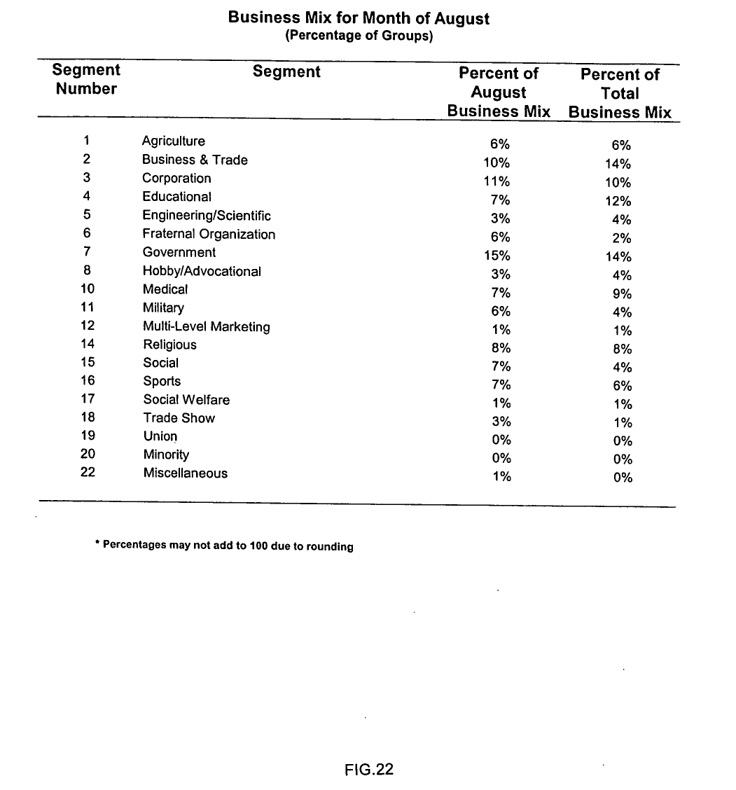

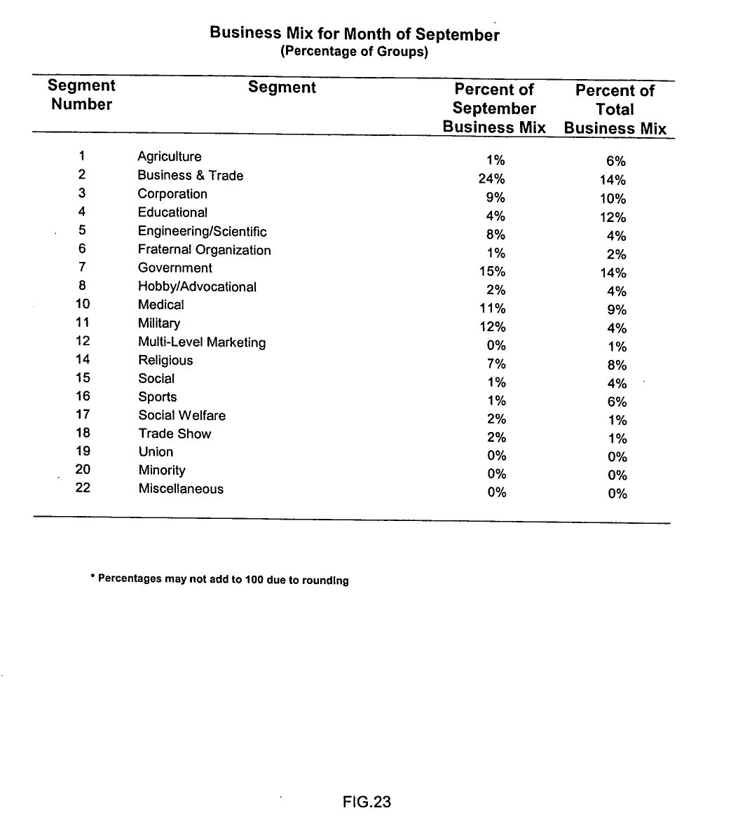

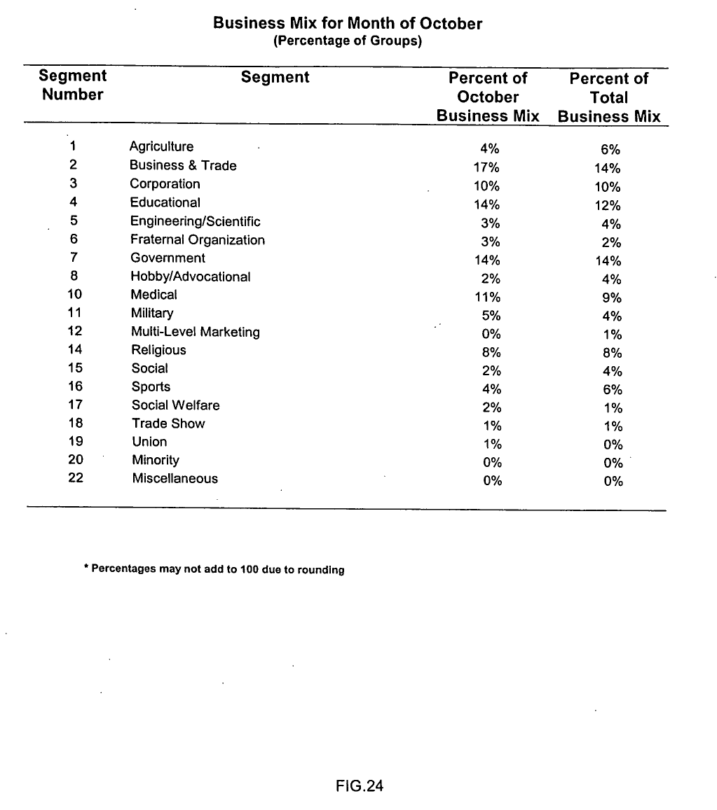

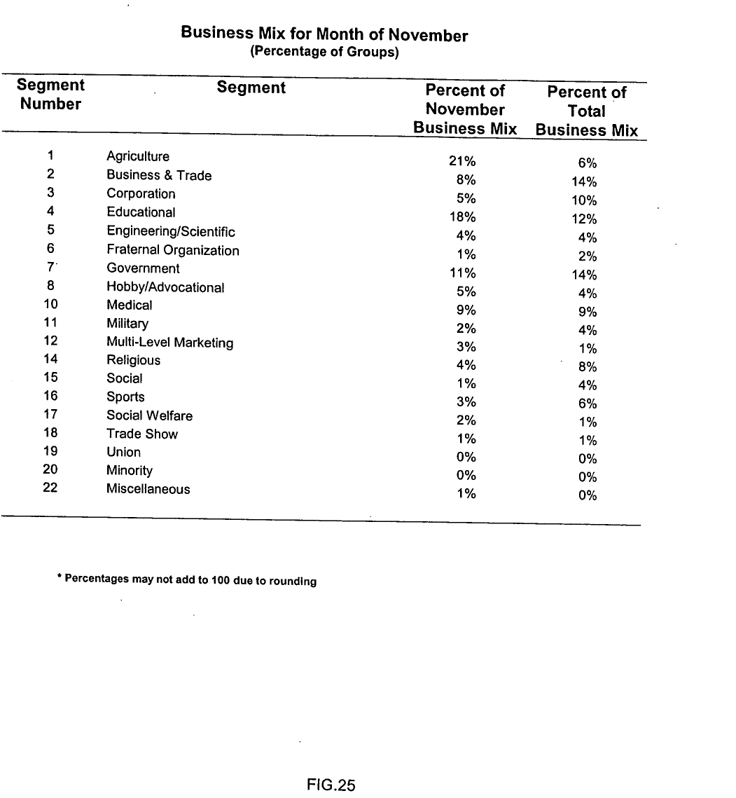

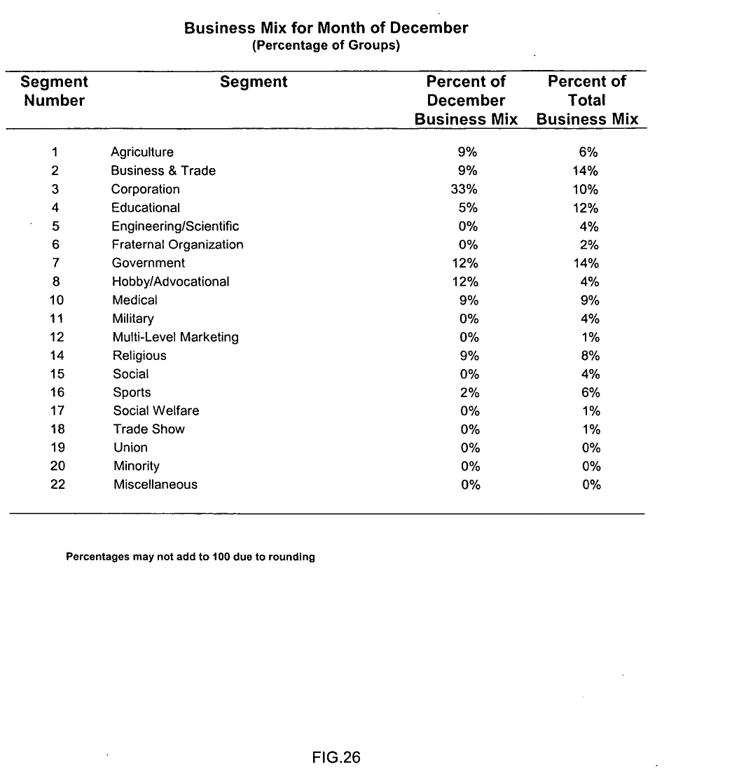

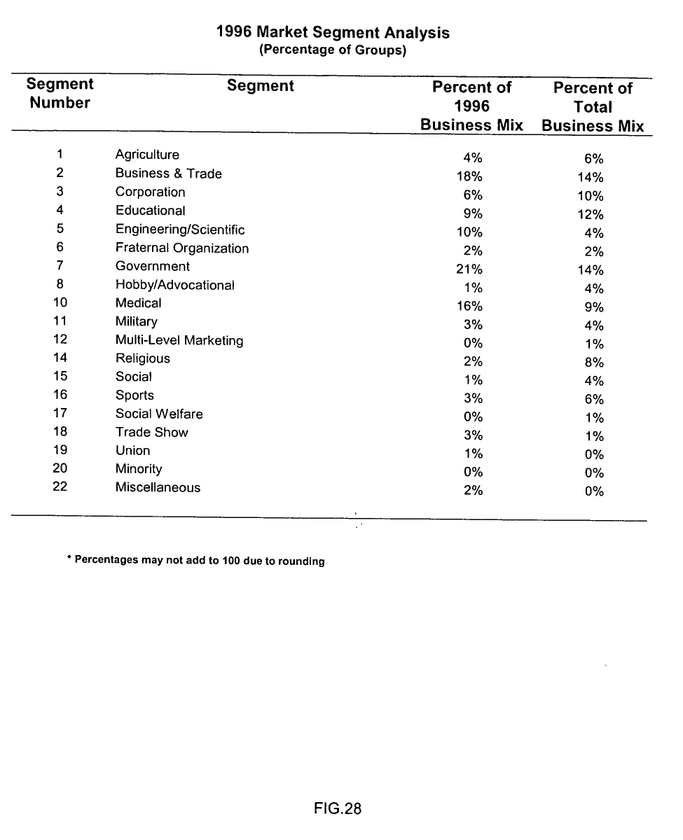

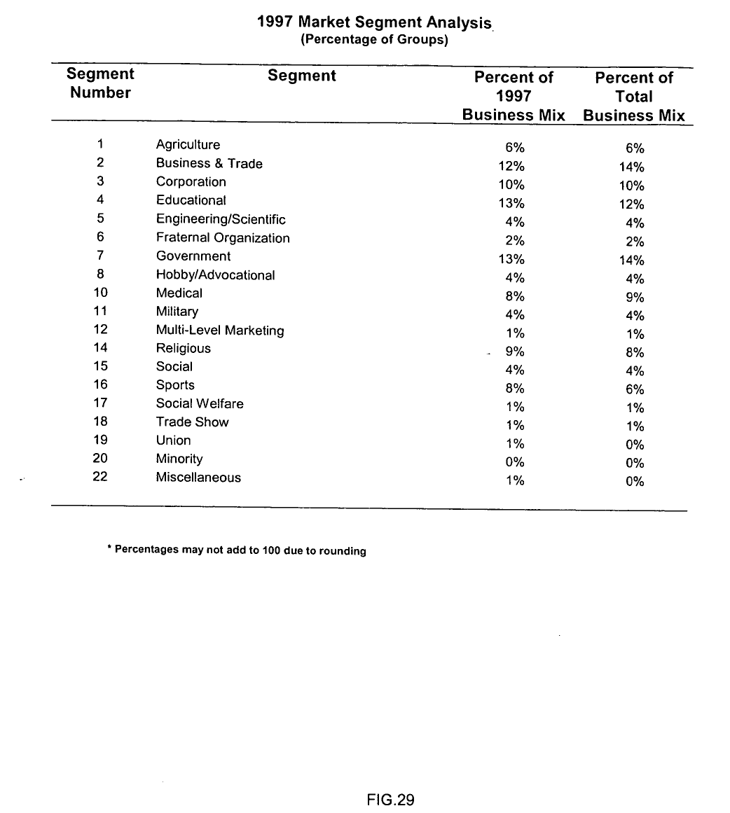

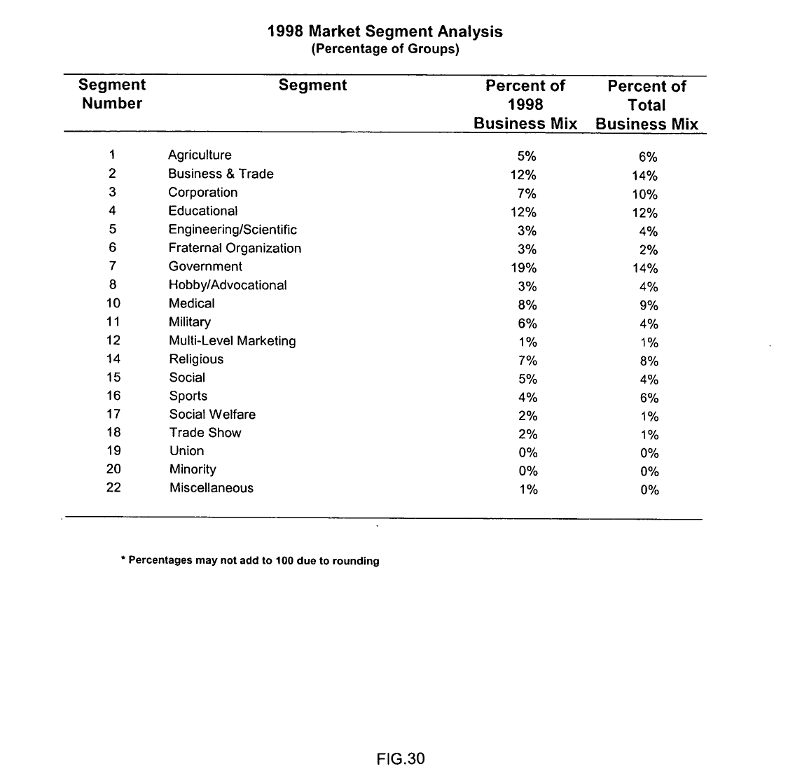

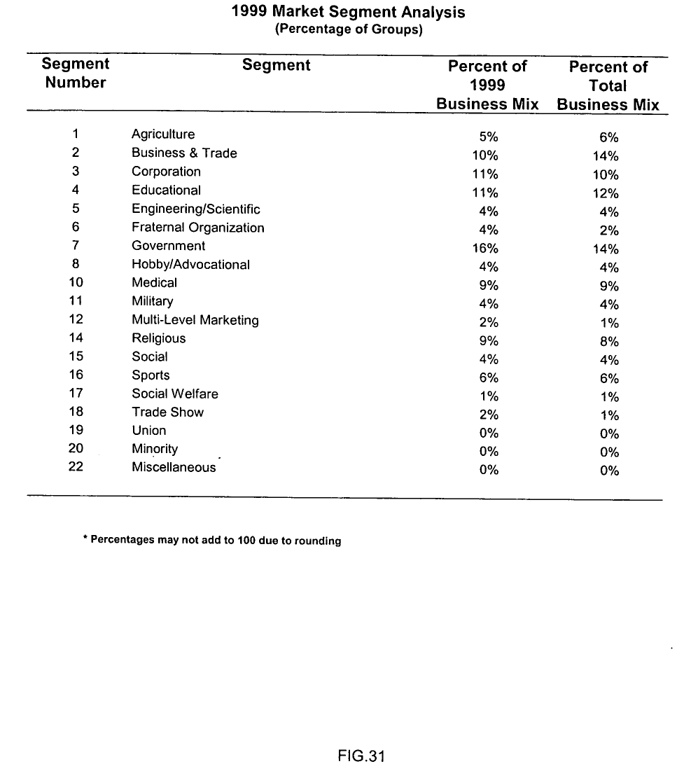

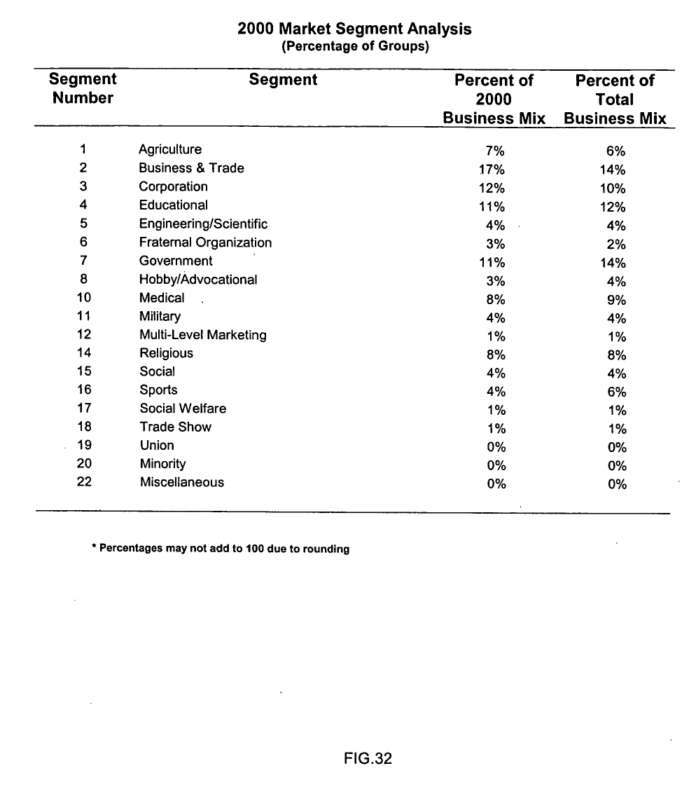

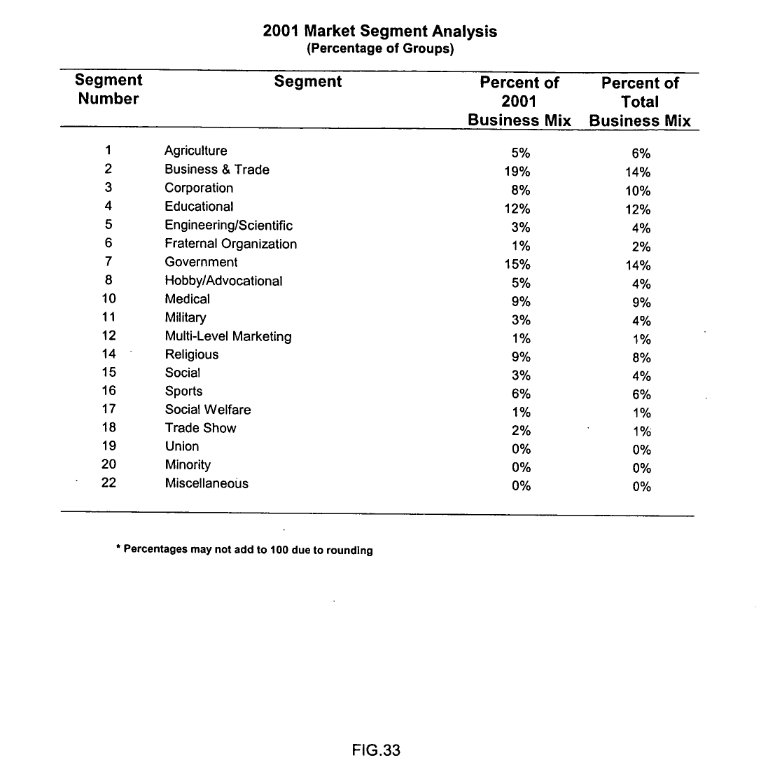

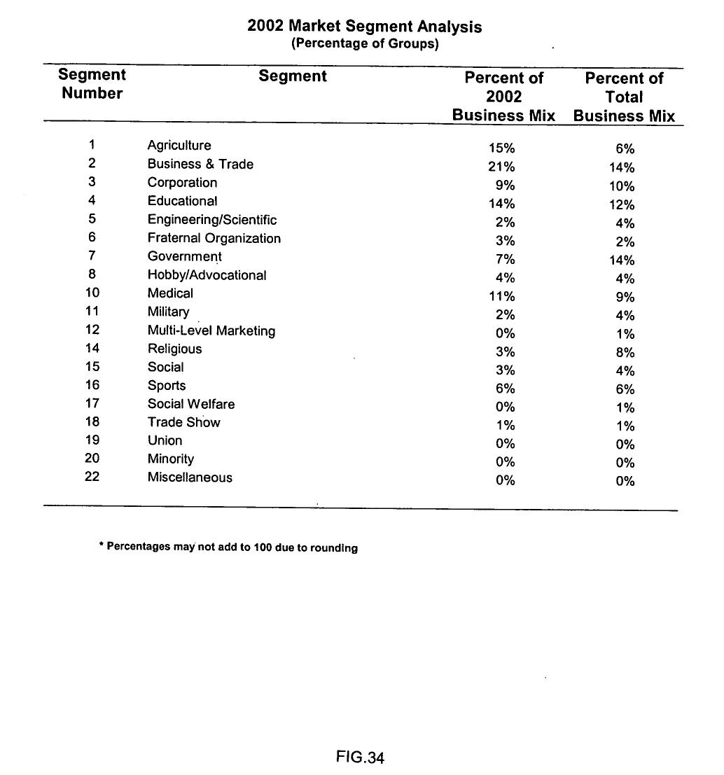

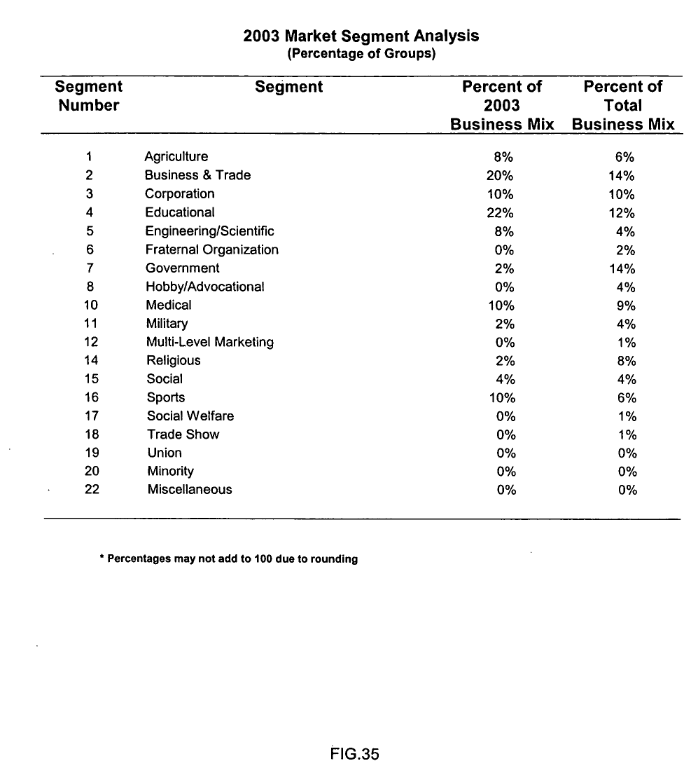

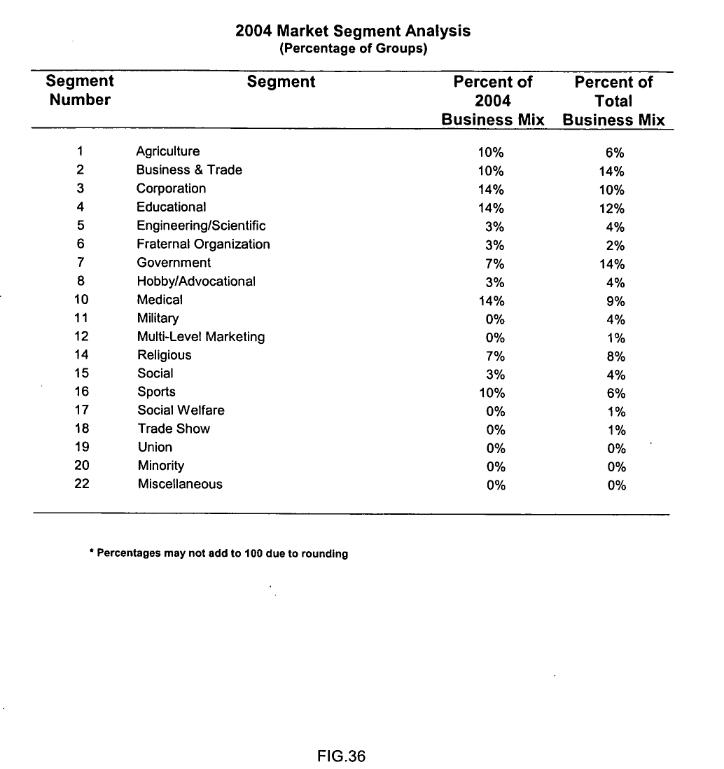

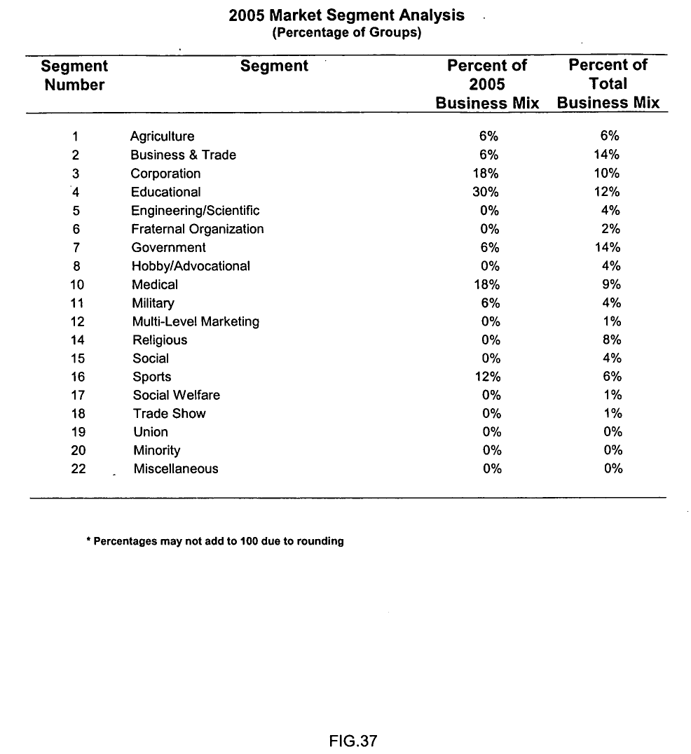

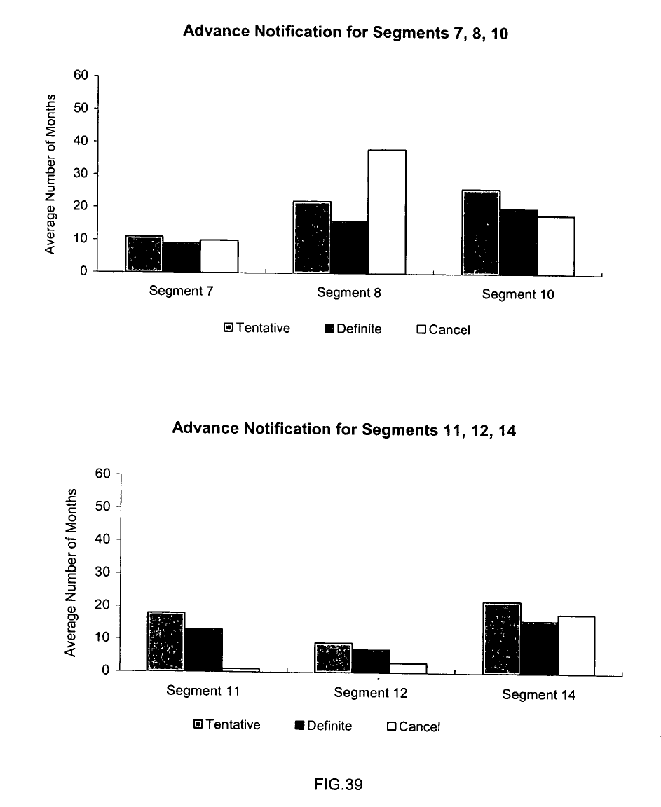

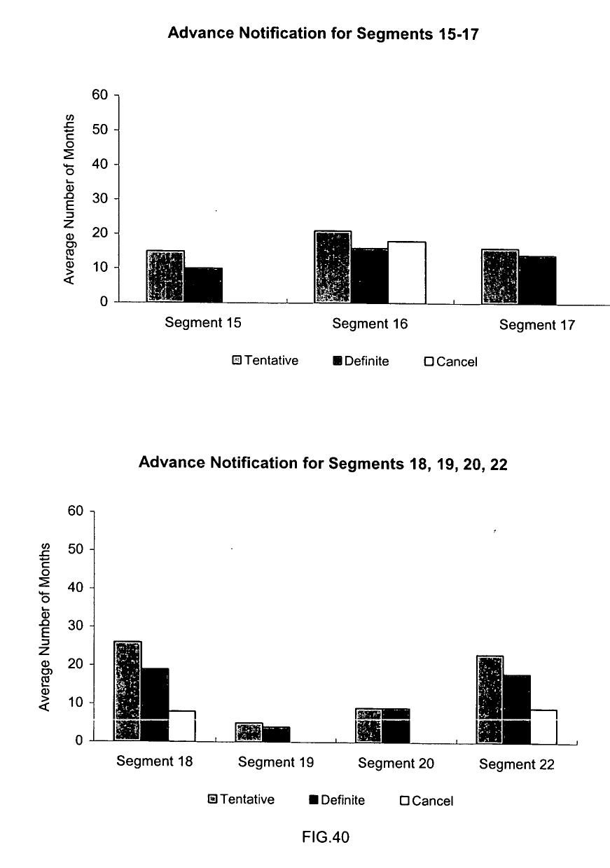

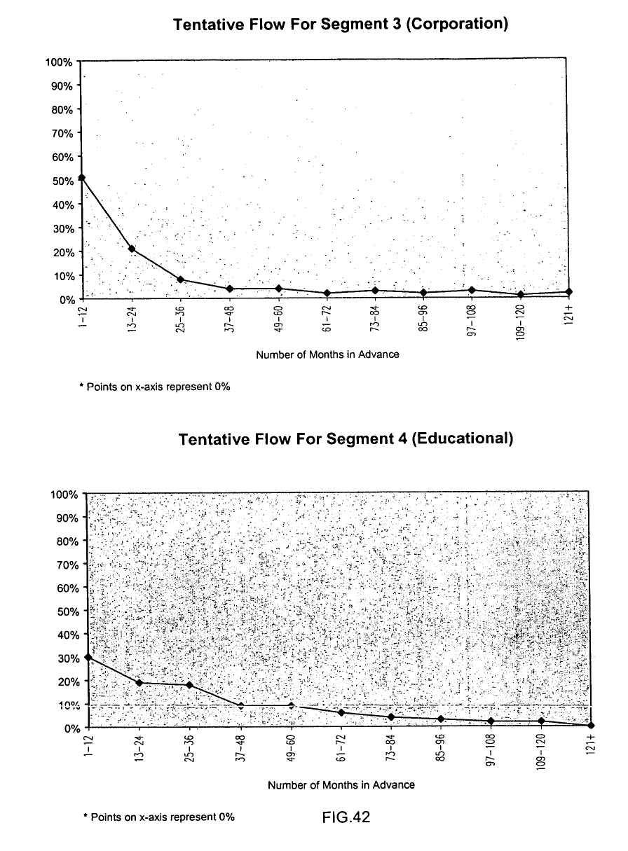

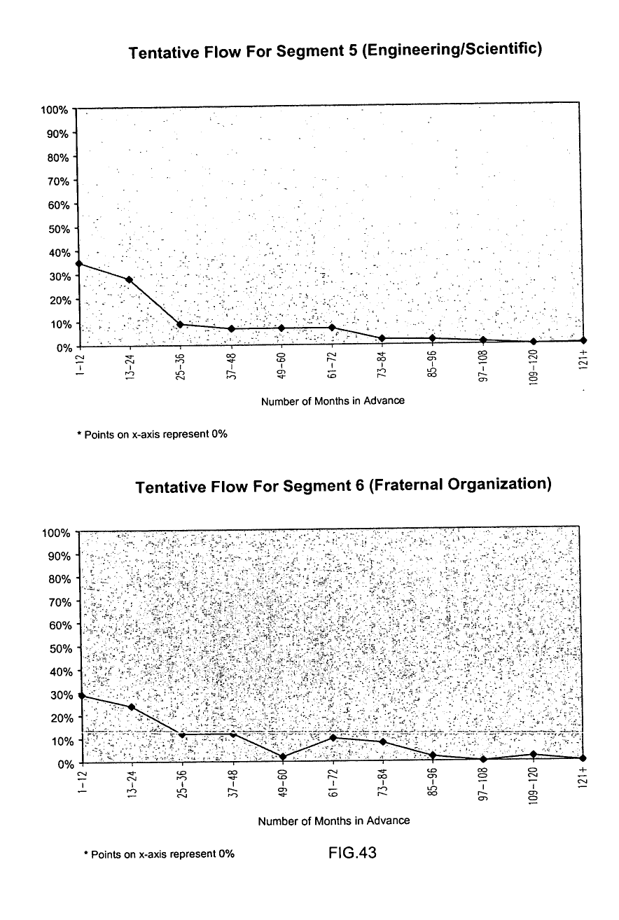

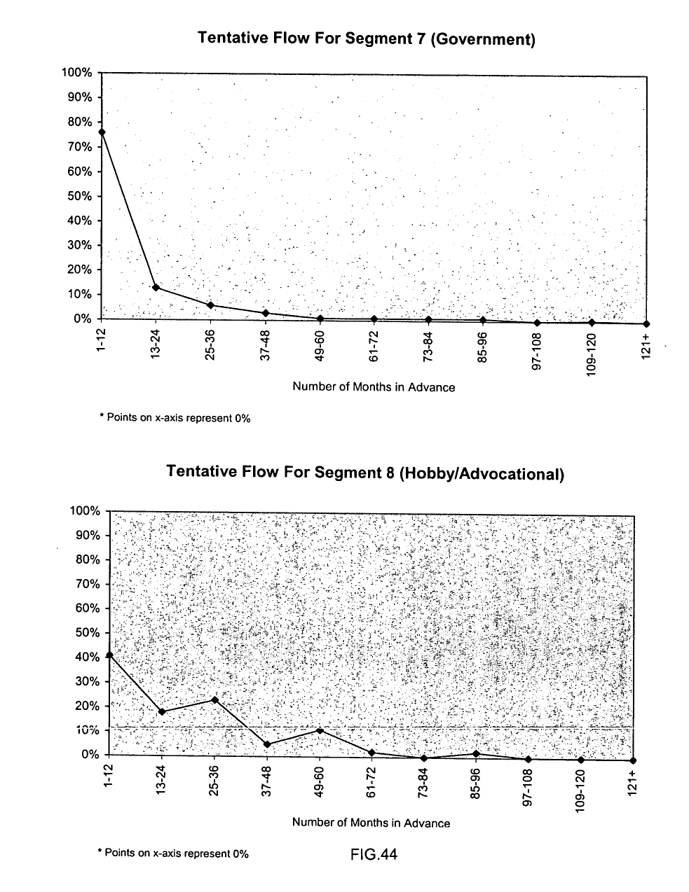

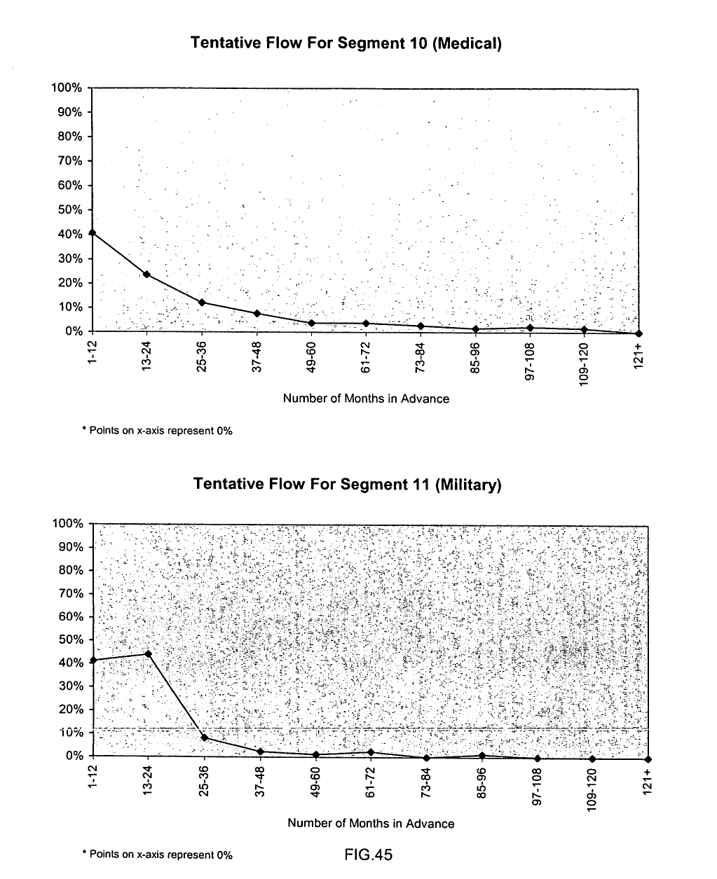

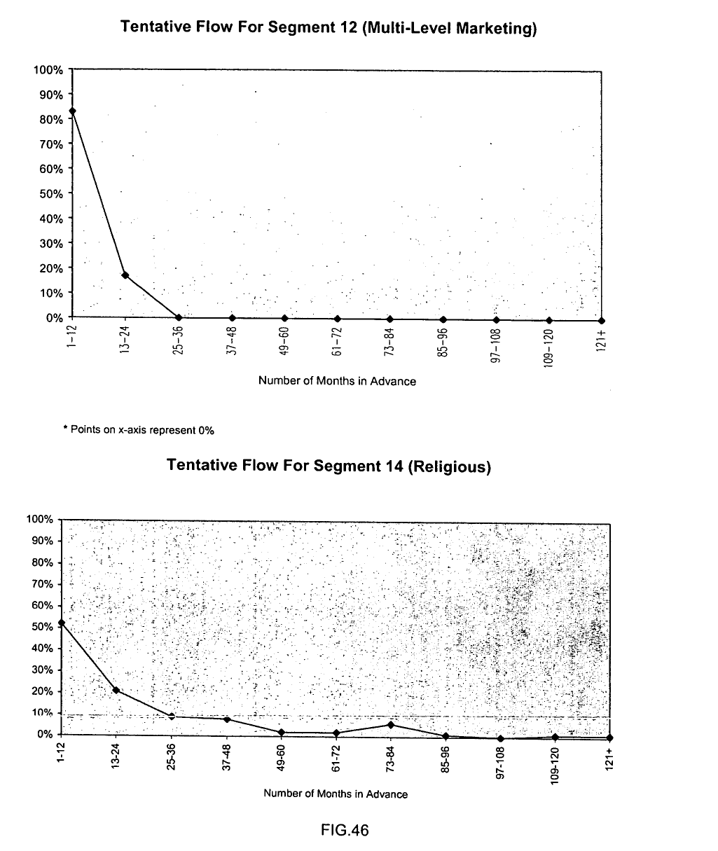

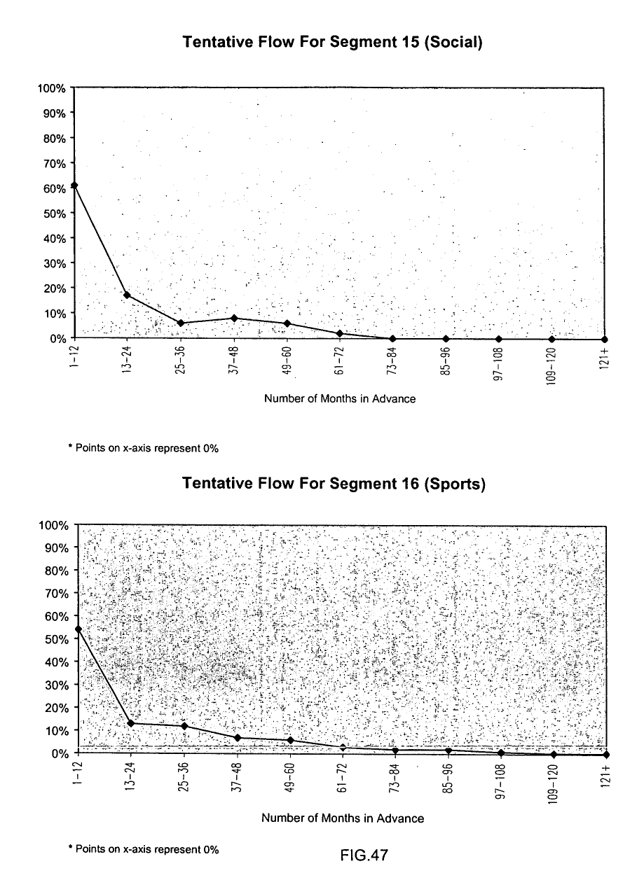

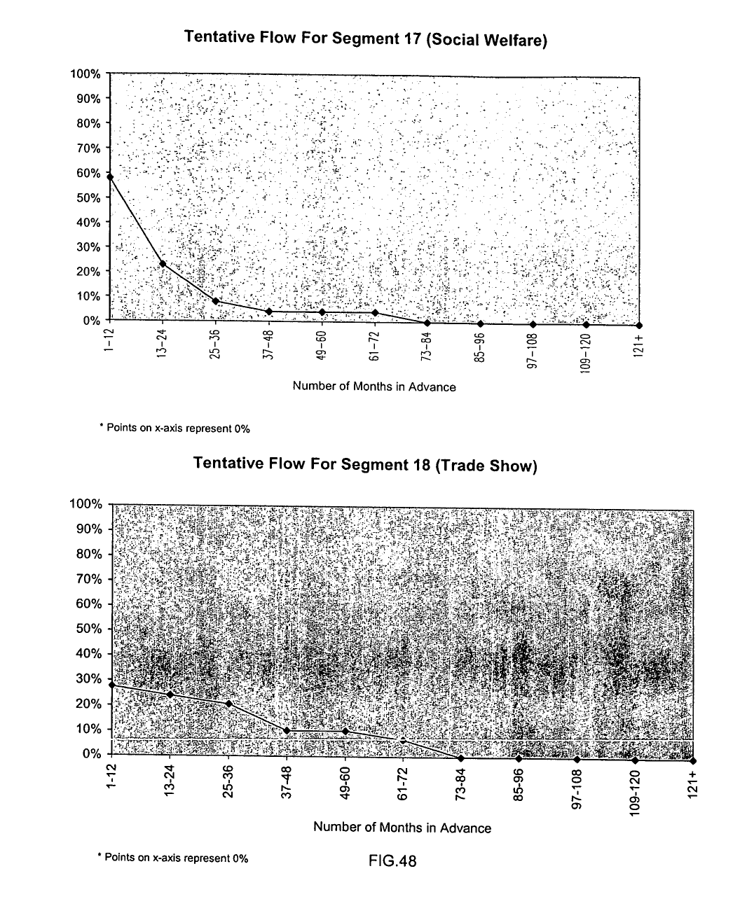

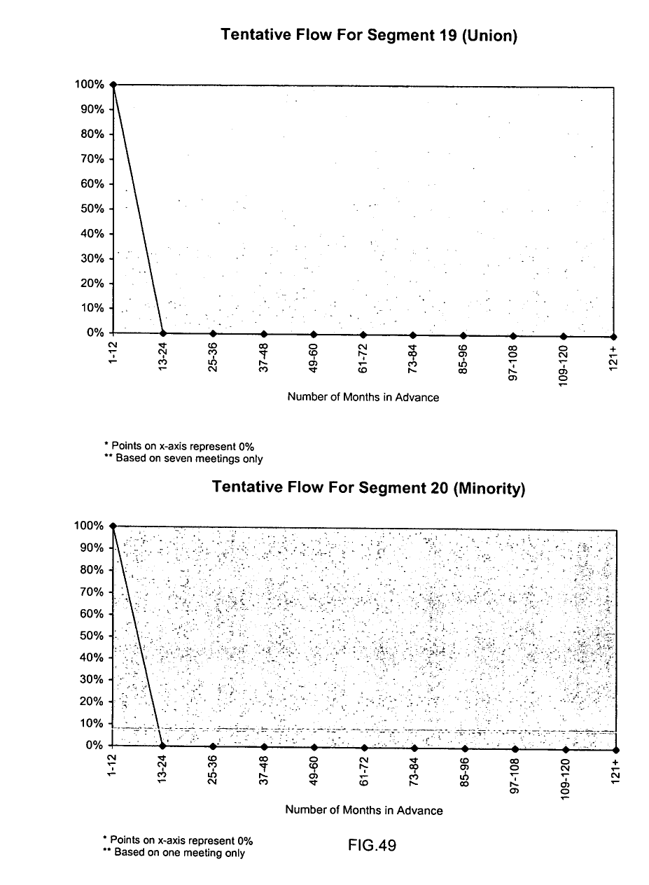

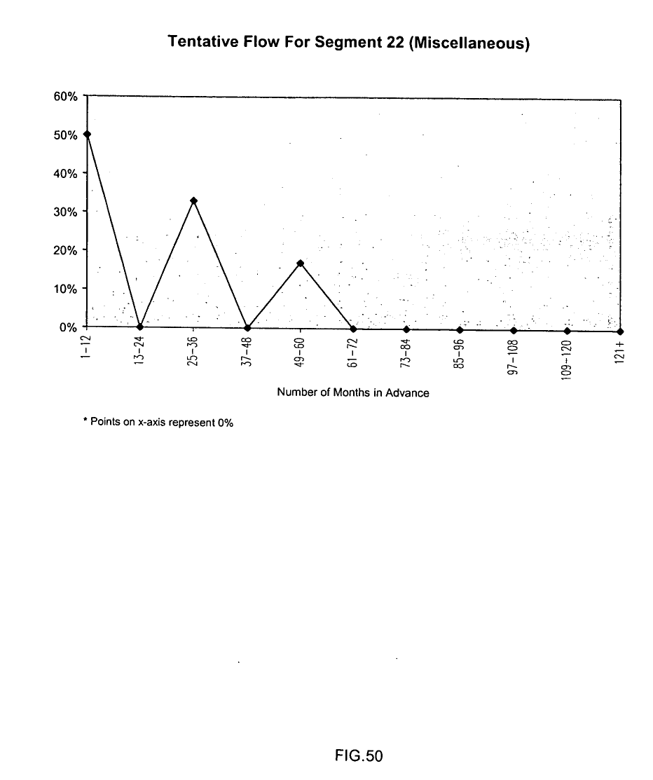

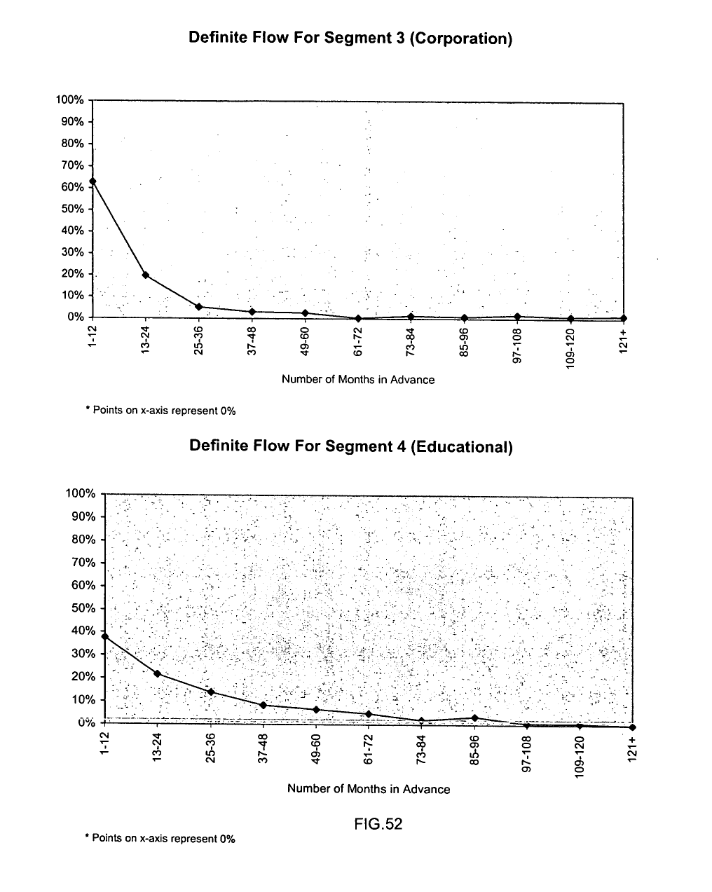

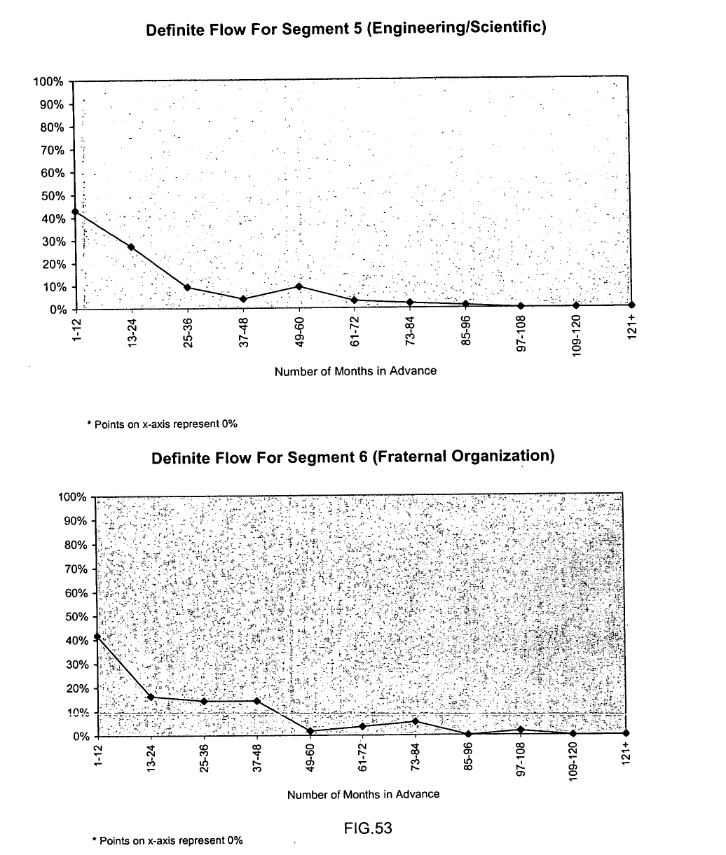

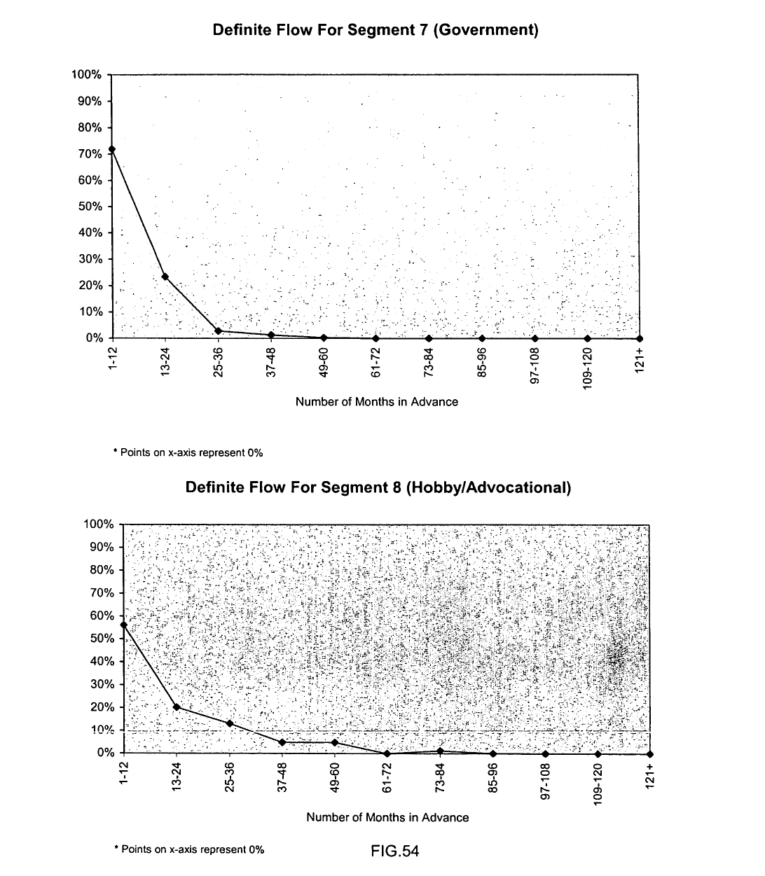

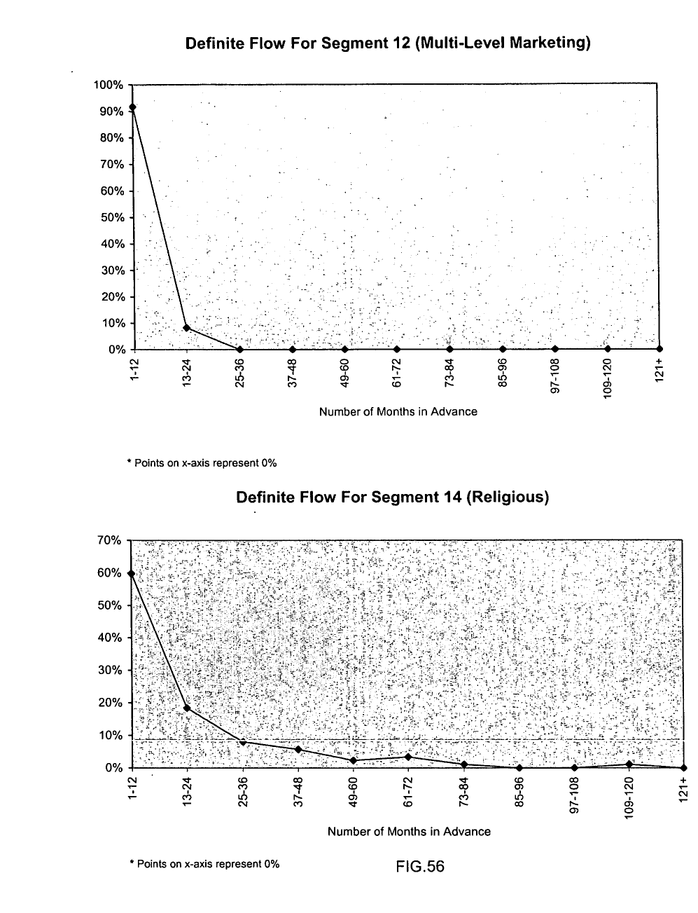

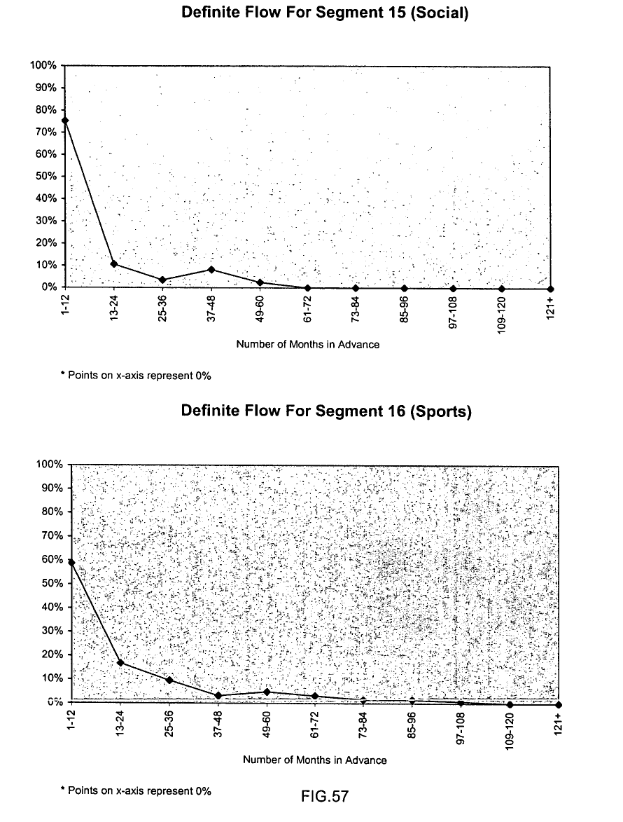

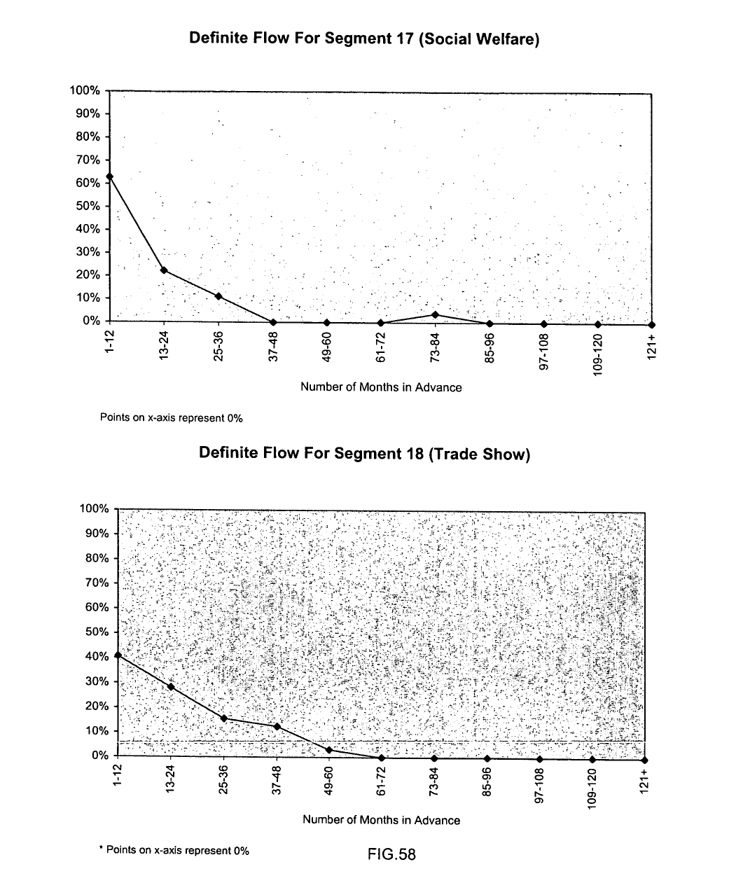

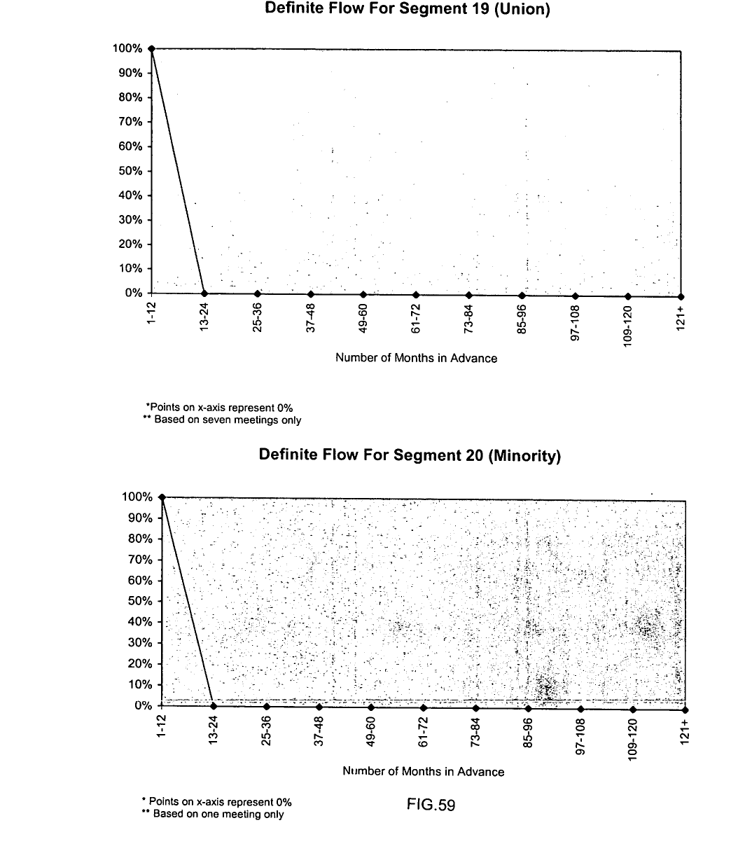

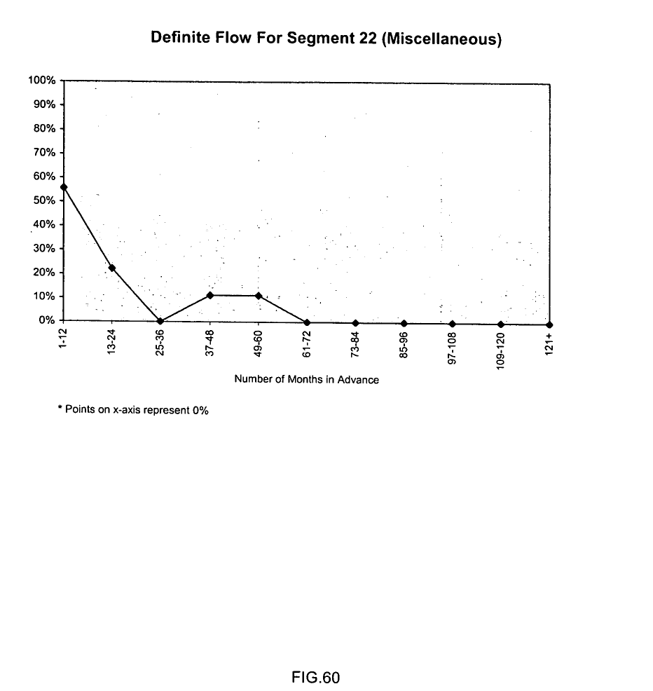

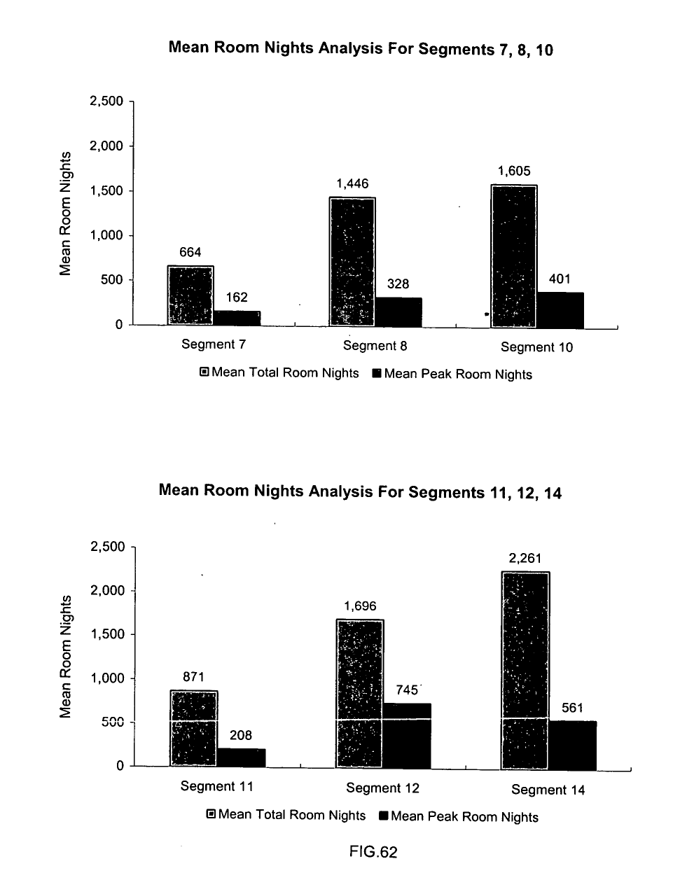

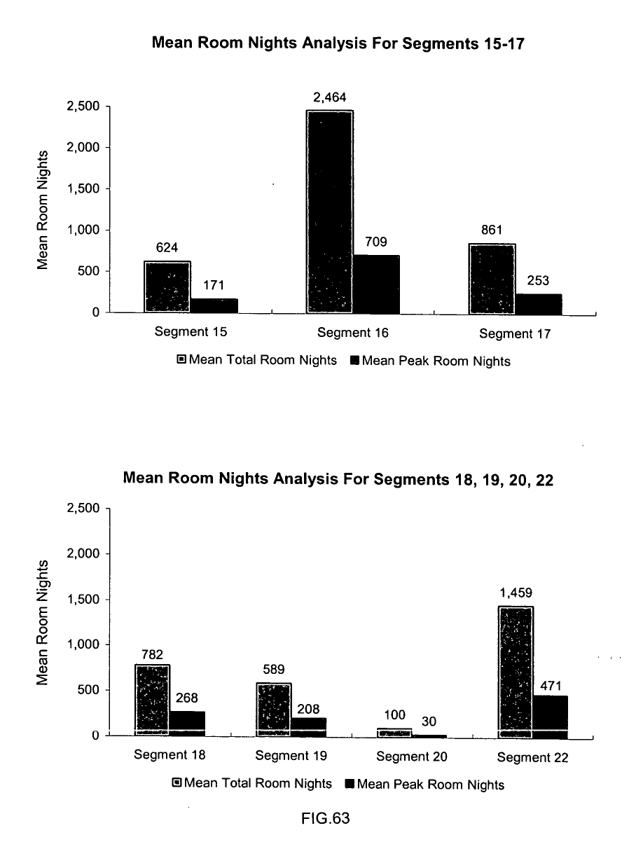

Yet another aspect of this invention can be used to analyze the characteristics for sources of business, or market segments, which consume products. An example of the analysis is provided in FIGS. 13-65 that uses the same data identified earlier in this detailed example of the application.

FIG. 13 shows the monthly flow of peak room night for the average group. While a convention group will use multiple nights, it is critical to know how many rooms are used on the largest single night, or peak room night. This is important because of the relatively inelastic supply of hotel rooms: the inventory cannot be increased to accommodate excess demand on a single night nor can rooms be stored in inventory for future use. Further, the sales force cannot sell more than the maximum number of rooms in the hotel or the city.

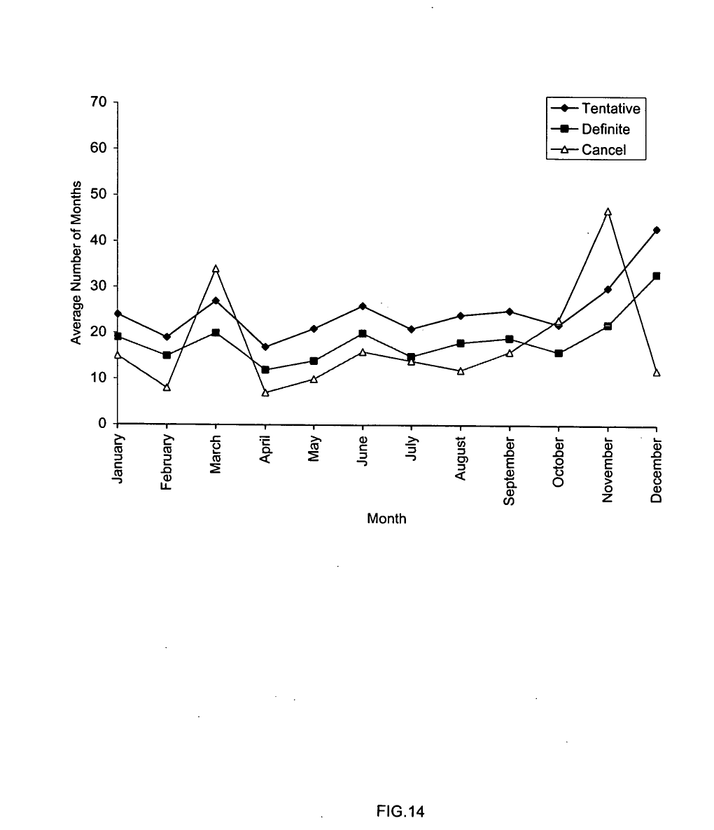

FIG. 14 provides a graphical representation of the output of the above-described algorithms regarding the patterns of how far in advance groups make tentative reservations, definite reservations, and cancel reservations.

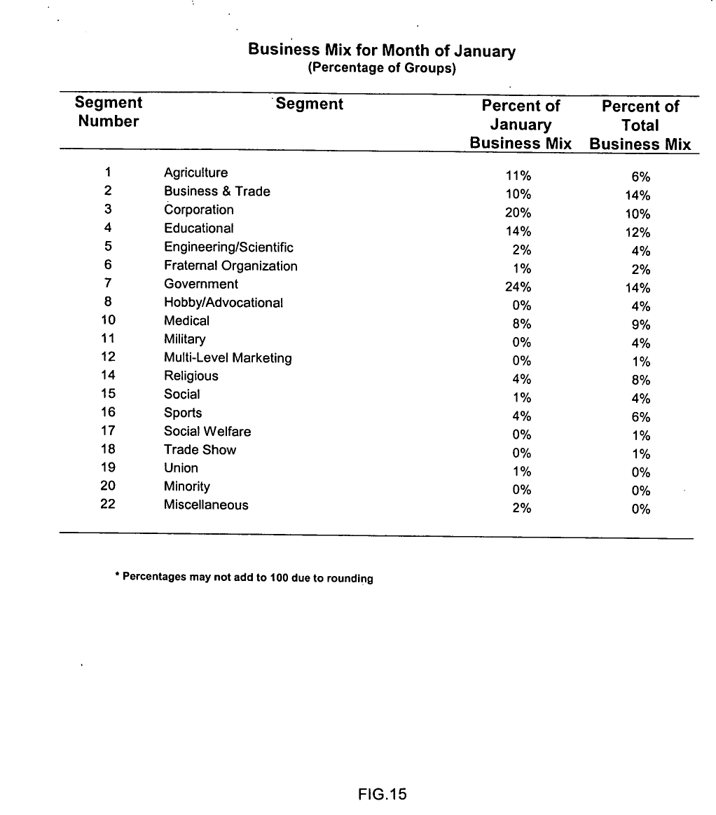

FIGS. 15-26 provide an analysis of the business mix, by month, for all the groups in the data set. Thus, it can be seen that for all January months, the single largest source of business, or the type of group that comes to the city, is in the “government” category with 24% followed by “corporation” at 20%, etc. The month of January stands in contrast to, say, November where the largest sources of business is with “agriculture” at 21% followed by “educational” at 18%.

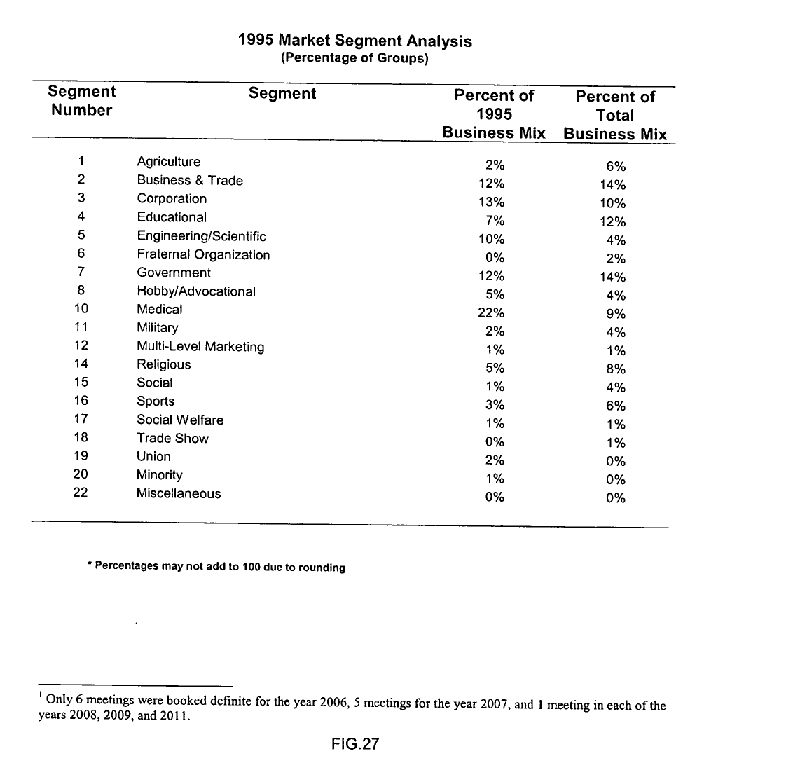

FIGS. 27-37 provide an analysis of the business mix by year for the ten-year period 1995 through 2005. It enables the organization to see how their “patterns of business” are changing over time. For example, in 1995 the largest source of business was “medical” representing 22% of the mix but by 2005 there is a shift with “engineering/scientific” representing 30% of the market.

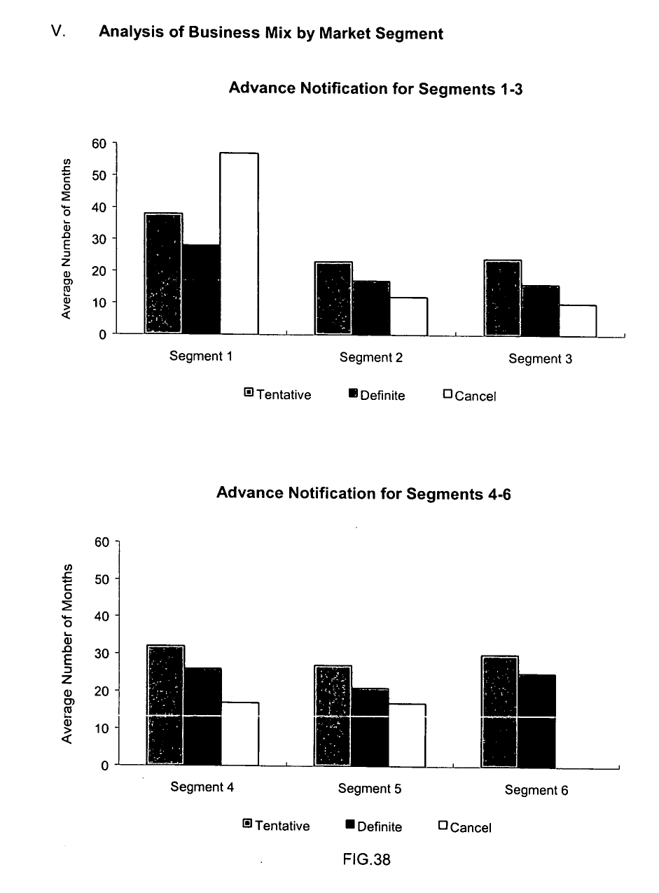

FIGS. 38-40 provide bar chart representations of the reservation or order taking patterns broken out by source of business or market segment. This data is used in later applications to target potential groups and develop probability predictions. It shows, for example, that the typical group from segment 2 places a tentative order/reservation about 23 months in advance of the date their event is to take place, makes a definite commitment/order/reservation 18 months in advance and, if they cancel will do so about 14 months in advance (note: these are means and, thus, the “cancel” figure may exceed the tentative and definite figures since relatively few groups cancel once they make a definite reservation/order).

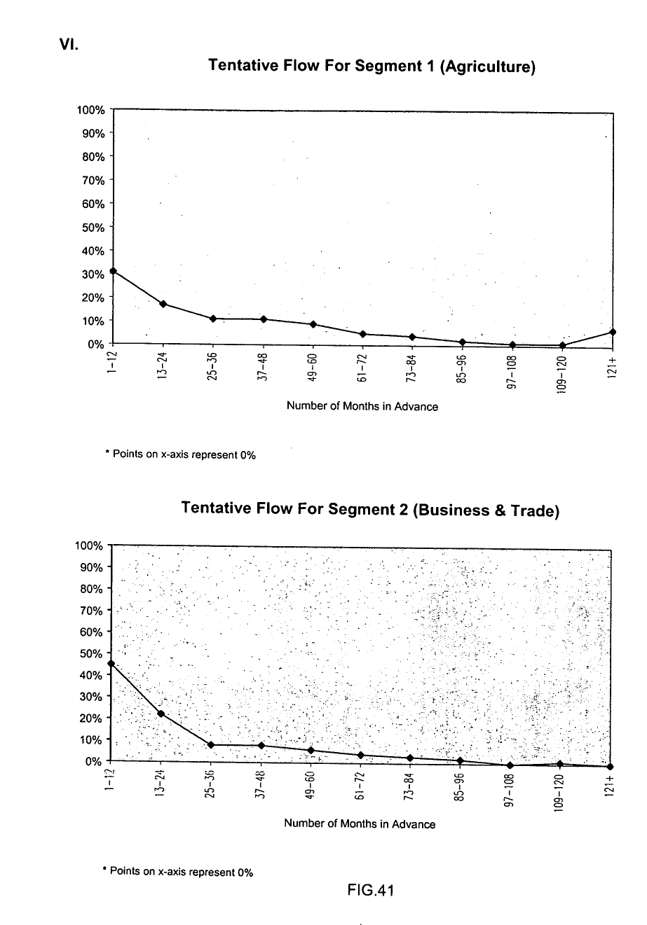

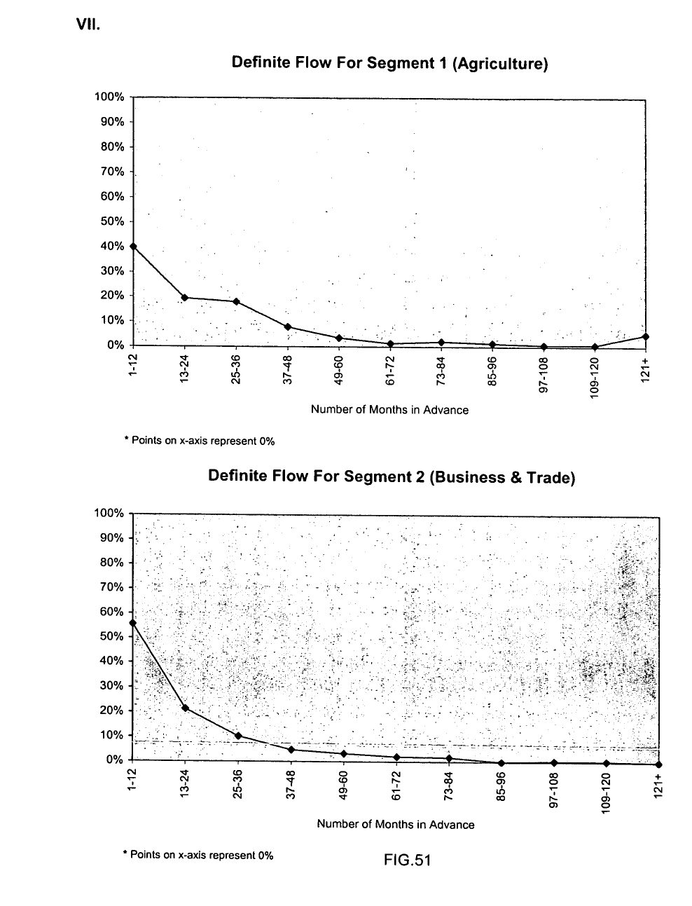

FIGS. 41-50 are more detailed line charts of the pattern of making tentative reservations/order while FIGS. 51-60 does the same for definite reservations/orders. The actual computer processing and data storage ascertains the percentage for each month; however, as done before, 12-month blocks are utilized for ease of illustration.

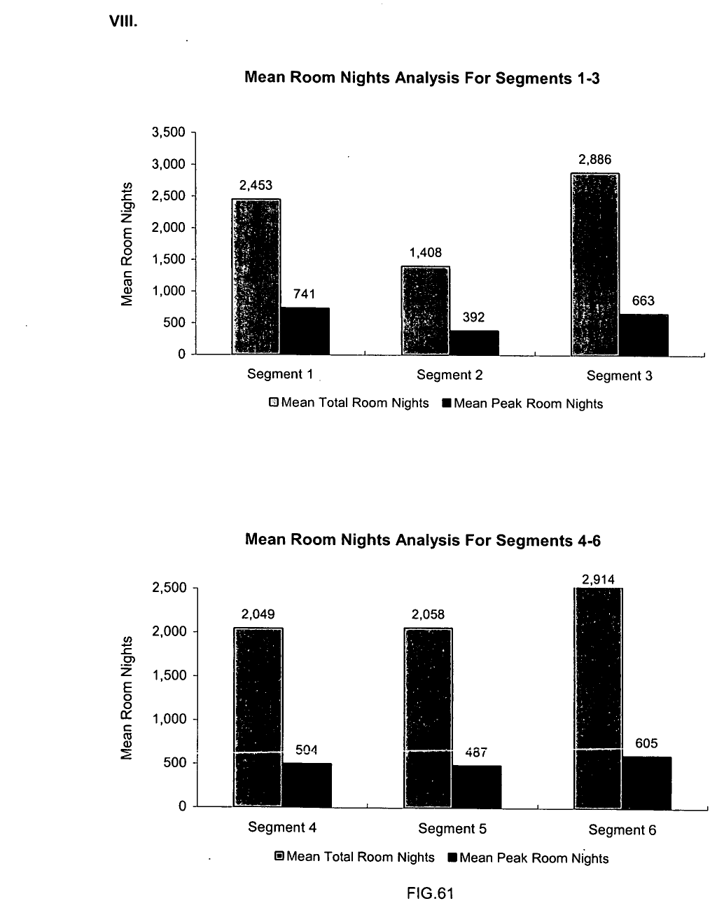

FIGS. 61-63 illustrates the output of the present invention regarding the number of room nights consumed by each market segment, or source of business. This is done for both the mean total room nights and the mean peak room nights. Thus it can be seen that in market segment 1 the typical group used 2,453 room nights during their stay and has a peak of 741 room nights on the single busiest day. By contract, in market segment 20 the typical group is much smaller, using only 30 room nights on their busiest night and a total of 100 room nights during their entire stay.

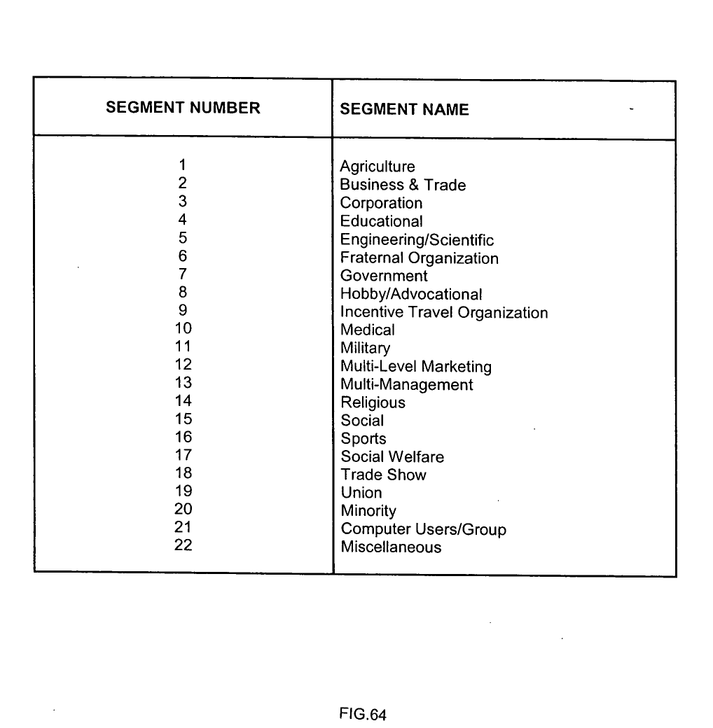

FIG. 64 provides labels for each of the numeric market segments to aid in understanding the illustrated data.

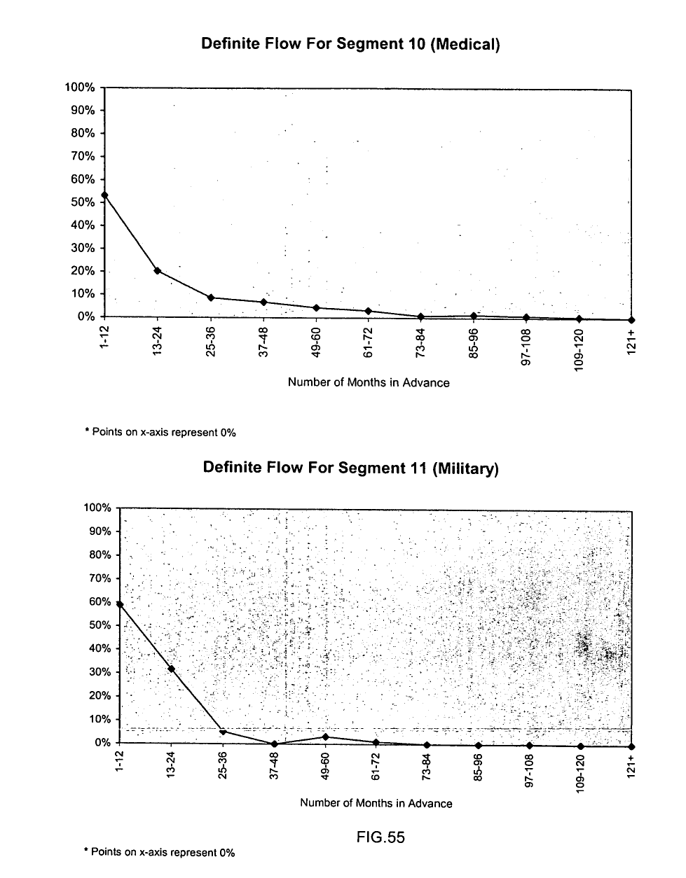

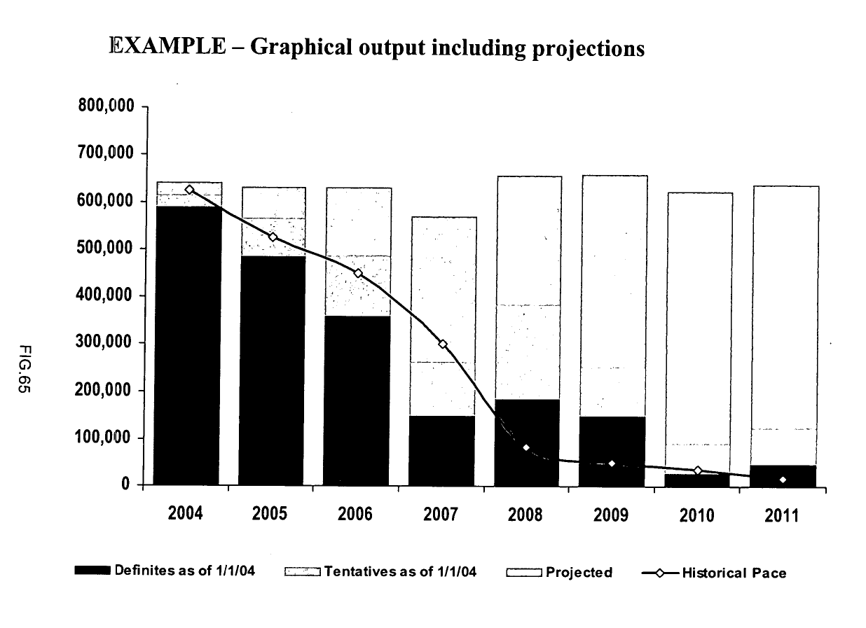

FIG. 65 takes the aforementioned application (illustrated throughout FIGS. 13-54) and puts much of the analysis in a single table. FIG. 65 shows that, as of January of 2004, there were just under 600,000 definite reservations/order for units/rooms and an additional 20,000 or so tentative orders/reservations for a total of just over 600,000. By using the present invention, it is shown that, for 2004, there should have been about 610,000 definite orders, thus putting forth an easy to read graph that shows the organization is short of their pace. On the other hand, FIG. 55 also shows that, for 2008 (4 years in the future) the organization is a ahead of where they should be, or ahead of pace, with about 200,000 room nights reserved/ordered, while they, historically would have had only 100,000 this far in advance of that end point or consumption point. This “being ahead of pace” is reflected in the higher “projected” part of the bar graph which shows that (because they are ahead of pace) they should expect to consume almost 400,000 room night/units in that year. Conversely, the fact that they are well short of pace in 2007 has the effect of dampening, or shrinking, the projections for that year.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

1. A method of monitoring progress toward a product consumption goal, comprising the steps of:
analyzing patterns of order activity;
ascertaining a consumption goal for a point in the future;
applying the patterns of order activity to the consumption goal;
determining the number of orders required at any period in advance of the consumption point to meet the consumption goal; and
comparing the number of orders required to meet the consumption goal with the orders actually made in any period in advance of the consumption point.

2. The method of claim 1, further including the step of calculating variances between the number of orders required to meet the consumption goal and the orders actually made in any period in advance of the consumption point.

3. The method of claim 2, further including the step of reporting positive or negative variances.

4. The method of claim 3, further including the step of producing a projected goal based on the positive or negative variances.

5. The method of claim 1, further including the step of reporting the number of orders required to meet the consumption goal and the orders actually made in any period in advance of the consumption point.

6. A method of determining ordering taking activity requirements to achieve multiple future consumption goals, comprising the steps of:
analyzing patterns of order activity for multiple future consumption points;
ascertaining consumption goals for the future consumption points;
identifying a period occurring before any of the future consumption points;
applying the patterns of order activity for each future consumption point to the period;
determining the total number of orders required to be placed in the period to meet the consumption goals; and
comparing the total number of orders required to be placed with the orders actually made, in the period.

7. The method of claim 6, further including the step of calculating variances between the total number of orders required and the orders actually made for a period or multiple periods.

8. The method of claim 7, further including the step of summing variances over multiple periods.

9. The method of claim 8, further including the step of reporting actual order activity, projected order activity and variances.

10. A method of analyzing market segment order activity for consumable products, comprising the steps of:
identifying an individual market segment;
analyzing patterns of order placement for the market segment for a future consumption date;
evaluating patterns of order placement for the market segment on a periodic basis prior to the consumption date.

11. The method of claim 10, further including the steps of:
ascertaining a product consumption goal for the market segment at a point in the future;
applying the patterns of order placement to the consumption goal;
determining the number of orders required at any period in advance of the consumption point to meet the consumption goal; and
comparing the number of orders required to the meet the consumption goal with the orders actually made in any period in advance of the consumption point.

12. The method of claim 11, further including the step of reporting actual and projected orders of market segments.

13. The method of claim 11, further including the step of coding all sources of business as market segments.

14. The method of claim 13, further including the step of determining the portion of the total of a market mix the market segment represents.

15. The method of claim 14, further including the step of analyzing market segments on a periodic basis.

16. The method of claim 15, wherein the market segments are analyzed on a monthly basis.

17. The method of claim 15, wherein the market segments are analyzed on an annual basis.

18. A method of targeting potential customers for consumable products, comprising the steps of:
analyzing patterns of order placement, ascertaining a consumption goal for a point in the future, applying the patterns of order placement to the consumption goal, determining the number of orders required at periods in advance of the consumption point to meet the consumption goal, and comparing the number of orders required to meet the consumption goal with the orders actually made in any period in advance of the consumption point;
identifying deficiencies in order activity in a period in advance of the consumption goal;
identifying an individual market segment, analyzing patterns of order placement for the market segment for a future consumption date, evaluating patterns of order placement for the market segment on a periodic basis prior to the consumption date, ascertaining a consumption goal for the market segment at a point in the future, applying the patterns of order placement to the consumption goal, determining the number of orders required at any period in advance of the consumption point to meet the consumption goal, and comparing the number of orders required to the meet the consumption goal with the orders actually made in any period in advance of the consumption point;
identifying market segments deficient in placing orders during the period;
identifying time periods when market segments typically place orders; and
identifying market segments likely to place orders.

19. The method of claim 18, further including the step of ranking the deficient market segments based on their patterns of order activity.

20. The method of claim 18, further including the step of reporting market segments likely to place orders in a probability table.

21. A computer-readable medium including instructions for controlling a data processing system to perform a method of monitoring progress toward a product consumption goal, comprising:
analyzing patterns of order activity;
ascertaining a consumption goal for a point in the future;
applying the patterns of order activity to the consumption goal;
determining the number of orders required at any period in advance of the consumption point to meet the consumption goal; and
comparing the number of orders required to meet the consumption goal with the orders actually made in any period in advance of the consumption point.

22. The computer-readable medium of claim 21, further including instructions for calculating variances between the number of orders required to meet the consumption goal and the orders actually made in any period in advance of the consumption point.

23. The computer-readable medium of claim 22, further including instructions for displaying positive or negative variances.

24. The computer-readable medium of claim 23, further including instructions for displaying a projected goal based on the positive or negative variances.

25. The computer-readable medium of claim 21, further including instructions for displaying the number of orders required to meet the consumption goal and the orders actually made in any period in advance of the consumption point.

26. A computer-readable medium including instructions for controlling a data processing system to perform a method of determining ordering taking activity requirements to achieve multiple future consumption goals, comprising:
analyzing patterns of order activity for multiple future consumption points;
ascertaining consumption goals for the future consumption points;
identifying a period occurring before any of the future consumption points;
applying the patterns of order activity for each future consumption point to the period;
determining the total number of orders required to be placed in the period to meet the consumption goals; and
comparing the total number of orders required to be placed with the orders actually made, in the period.

27. The computer-readable medium of claim 26, further including instructions for calculating variances between the total number of orders required and the orders actually made for a period or multiple periods.

28. The computer-readable medium of claim 27, further including instructions for summing variances over multiple periods.

29. The computer-readable medium of claim 28, further including instructions for displaying actual order activity, projected order activity and variances.

30. A computer-readable medium including instructions for controlling a data processing system to perform a method of analyzing market segments of consumable products, comprising:
identifying an individual market segment;
analyzing patterns of order placement for the market segment for a future consumption date; and
evaluating patterns of order placement for the market segment on a periodic basis prior to the consumption date.

31. The computer-readable medium of claim 30, further including instructions for:
ascertaining a product consumption goal for the market segment at a point in the future;
applying the patterns of order placement to the consumption goal;
determining the number of orders required at any period in advance of the consumption point to meet the consumption goal; and
comparing the number of orders required to the meet the consumption goal with the orders actually made in any period in advance of the consumption point.

32. The computer-readable medium of claim 31, further including instructions for displaying actual and projected orders of market segments.

33. The computer-readable medium of claim 31, further including instructions for coding all sources of business as market segments.

34. The computer-readable medium of claim 33, further including instructions for determining the portion of the total of a market mix the market segment represents.

35. The computer-readable medium of claim 34, further including instructions for analyzing market segments on a periodic basis.

36. The computer-readable medium of claim 35, wherein the instructions analyze the market segments on a monthly basis.

37. The computer-readable medium of claim 35, wherein the instructions analyze the market segments on an annual basis.

38. A computer-readable medium including instructions for controlling a data processing system to perform a method of targeting potential customers for consumable products, comprising:
analyzing patterns of order placement, ascertaining a consumption goal for a point in the future, applying the patterns of order placement to the consumption goal, determining the number of orders required at periods in advance of the consumption point to meet the consumption goal, and comparing the number of orders required to meet the consumption goal with the orders actually made in any period in advance of the consumption point;
identifying deficiencies in order activity in a period in advance of the consumption goal;
identifying an individual market segment, analyzing patterns of order placement for the market segment for a future consumption date, evaluating patterns of order placement for the market segment on a periodic basis prior to the consumption date, ascertaining a consumption goal for the market segment at a point in the future, applying the patterns of order placement to the consumption goal, determining the number of orders required at any period in advance of the consumption point to meet the consumption goal, and comparing the number of orders required to the meet the consumption goal with the orders actually made in any period in advance of the consumption point;
identifying market segments deficient in placing orders during the period;
identifying time periods when market segments typically place orders; and
identifying market segments likely to place orders.

39. The computer-readable medium of claim 38, further including instructions for ranking the deficient market segments based on their patterns of order activity.

40. The computer-readable medium of claim 38, further including instructions for displaying market segments likely to place orders in a probability table.
